(19) United States
(12) Patent Application Publication
(10) Pub. No.: US 2024/0010770 A1
(43) Pub. Date: Jan. 11, 2024

(54) HYDROCARBYL-MODIFIED METHYLALUMINOXANE COCATALYSTS FOR BIS-PHENYLPHENOXY METAL-LIGAND COMPLEXES

(71) Applicant: Dow Global Technologies LLC, Midland, MI (US)

(72) Inventors: Philip P. Fontaine, Lake Jackson, TX (US); David M. Pearson, Lake Jackson, TX (US); Hien Q. Do, Lake Jackson, TX (US); Johnathan E. Delorbe, Lake Jackson, TX (US); Rafael Huacuja, Lake Jackson, TX (US); Rhett A. Baillie, Lake Jackson, TX (US)

(73) Assignee: Dow Global Technologies LLC, Midland, MI (US)

(21) Appl. No.: 18/005,750

(22) PCT Filed: Feb. 5, 2021
(86) PCT No.: PCT/US2021/016789

§ 371 Date: Jan. 17, 2023

Related U.S. Application Data
(60) Provisional application No. 63/053,342, filed on Jul. 17, 2020.

(51) Int. Cl. C08F 210/16; C08F 4/659

(52) U.S. Cl. CPC C08F 210/16; C08F 4/65912

(57) ABSTRACT

Processes of polymerizing olefin monomers. The process comprising reacting ethylene and optionally one or more olefin monomers in the presence of a catalyst system, wherein the catalyst system comprises: hydrocarbyl-modified methylaluminoxane having less than 25 mole percent trihydrocarbyl aluminum compounds AlR^{A1}R^{B1}R^{C1} based on the total moles of aluminum, where R^{A1}, R^{B1}, and R^{C1} are independently linear (C₁-C₄₀)alkyl, branched (C₁-C₄₀)alkyl, or (C₆-C₄₀)aryl; and one or more metal-ligand complexes according to formula (I):

### CROSS REFERENCE TO RELATED APPLICATIONS

This application claims priority to U.S. Provisional Patent Application No. 63/053,342, filed on Jul. 17, 2020, the entire disclosure of which is hereby incorporated by reference.

### TECHNICAL FIELD

Embodiments of the present disclosure generally relate to hydrocarbyl-modified methylaluminoxane activators for catalysts systems including bis-phenylphenoxy metal-ligand complexes.

### BACKGROUND

Since the discovery of Ziegler and Natta on heterogeneous olefin polymerizations, global polyolefin production reached approximately 150 million tons per year in 2015, and it is rising due to increasing market demand. This success is based in part on a series of important breakthroughs in co-catalyst technology. The co-catalysts discovered include aluminoxanes, boranes, and borates with triphenylcarbenium or ammonium cations. These co-catalysts activate the homogeneous single-site olefin polymerization procatalysts, and polyolefins have been produced using these co-catalysts in industry.

As part of the catalyst composition in α-olefin polymerization reactions, the activator may have characteristics that are beneficial for the production of the α-olefin polymer and for final polymer compositions including the α-olefin polymer. Activator characteristics that increase the production of α-olefin polymers include, but are not limited to: rapid procatalyst activation, high catalyst efficiency, high temperature capability, consistent polymer composition, and selective deactivation.

Borate based co-catalysts in particular have contributed significantly to the fundamental understanding of olefin polymerization mechanisms, and have enhanced the ability for precise control over polyolefin microstructures by deliberately tuning catalyst structures and processes. This results in stimulated interest in mechanistic studies and lead to the development of novel homogeneous olefin polymerization catalyst systems that have precise control over polyolefin microstructures and performance. However, once the cations of the activator or co-catalyst activate the procatalyst, the counter ion of the activator may remain in the polymer composition. As a result, the borate anions may affect the polymer composition. In particular, the size of the borate anion, the charge of the borate anion, the interaction of the borate anion with the surrounding medium, and the dissociation energy of the borate anion with available counterions will affect the ion's ability to diffuse through a surrounding medium such as a solvent, a gel, or a polymer material.

Modified methylaluminoxanes (MMAOs) can be described as a mixture of aluminoxane structures and trihydrocarbylaluminum species. Trihydrocarbylaluminum species, like trimethylaluminum are used as scavengers to remove impurities in the polymerization process which may contribute to the deactivation of the olefin polymerization catalyst. However, it is believed that trihydrocarbylaluminum species may be active in some polymerization systems. Catalyst inhibition has been noted when trimethylaluminum is present in propylene homopolymerizations with hafnocene catalysts at 60° C. (Busico, V. et. al. Macromolecules 2009, 42, 1789-1791). However, these observations convolute differences in MAO-activation versus borate activation, and even in direct comparison only possibly capture differences between some trimethylaluminum and none. Additionally, it is unclear that such observations extend to other catalysts systems, to ethylene polymerization, or to polymerizations conducted at higher temperatures. Regardless, the preference for soluble MAOs necessitates the use of MMAO and hence the presence of trihydrocarbylaluminum species.

Modified methylaluminoxanes (MMAO) are used as activators in some PE processes in place of borate based activators. However, MMAO has been found to have negative impact on the performance of some catalysts, such as some bis-phenylphenoxy procatalysts, and have negatively impacted the production of polymer resins. The negative impact on the polymerization process includes decreasing catalyst activity, broadening composition distribution of the produced polymer, and negatively affecting the pellet handling.

### SUMMARY

There is an ongoing need to create a catalyst system while maintaining catalyst efficiency, reactivity, and the ability to produce polymers with good physical properties.

Embodiments of this disclosure includes processes of polymerizing olefin monomers. In one or more embodiments, the process includes reacting ethylene and optionally one or more olefin monomers in the presence of a catalyst system. The catalyst system includes hydrocarbyl-modified methylaluminoxane and a metal-ligand complex. The hydrocarbyl-modified methylaluminoxane having less than 25 mole percent trihydrocarbyl aluminum compound AlR^{A}R^{B}R^{C} based on the total moles of aluminum in the hydrocarbyl-modified methylaluminoxane, where R^{A}, R^{B}, and R^{C} are independently (C₁-C₄₀)alkyl; and one or more metal-ligand complexes according to formula (I):

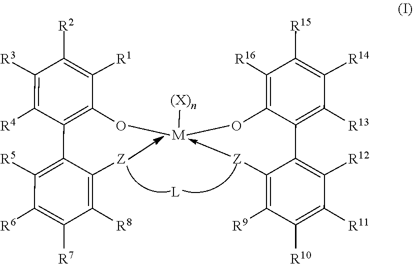

In formula (I), M is titanium, zirconium, hafnium, yttrium, or an element of the lanthanide series of the periodic table having a formal oxidation state of +2, +3, or +4. Subscript n of (X)ₙ is 1, 2, or 3. Each X is a monodentate ligand independently chosen from unsaturated (C₂-C₅₀)hydrocarbon, unsaturated (C₂-C₅₀)heterohydrocarbon, saturated (C₂-C₅₀)heterohydrocarbon, (C₁-C₅₀)hydrocarbyl, (C₆-C₅₀)aryl, (C₆-C₅₀)heteroaryl, cyclopentadienyl, substituted cyclopentadienyl, (C₄-C₁₂)diene, halogen, —N(R^{N})₂, and —N(R^{N})COR^{C}. The metal-ligand complex is overall charge-neutral. Each Z is independently chosen from —O—, —S—, —N(R^{N})—, or —P(R^{P})—. L is (C₁-C₄₀)hydrocarbylene or (C₂-C₄₀)heterohydrocarbylene.

In formula (I), R², R³, R⁴, R⁵, R⁶, R⁷, R⁸, R⁹, R¹⁰, R¹¹, R¹², R¹³, R¹⁴, and R¹⁵ are independently selected from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R)—, (R^{C})₂NC(O)—, and halogen.

In formula (I), R¹ and R¹⁶ are independently selected from the group consisting of —H, (C₁-C₄₀)hydrocarbyl, (C₁-C₄₀)heterohydrocarbyl, —Si(R^{C})₃, —Ge(R^{C})₃, P(R^{P})₂, —N(R^{N})₂, —OR^{C}, —SR^{C}, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, halogen, radicals having formula (II), radicals having formula (III), and radicals having formula (IV):

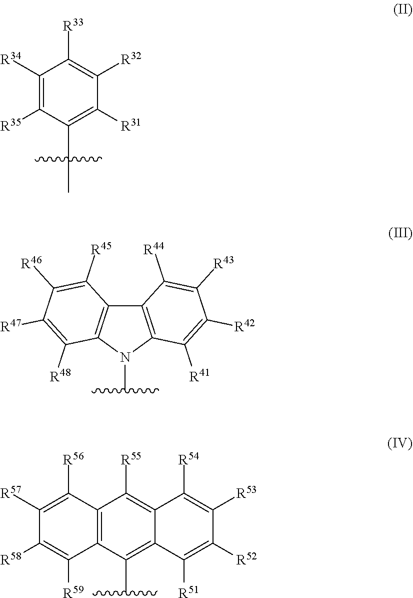

In formulas (II), (III), and (IV), each of R³¹⁻³⁵ R⁴¹⁻⁴⁸ and R⁵¹⁻⁵⁹ is independently chosen from —H, (C₁-C₄₀)hydrocarbyl, (C₁-C₄₀)heterohydrocarbyl, —Si(R^{C})₃, —Ge(R^{C})₃, P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, or halogen.

In formulas (I), (II), (III), and (IV), each R^{C}, R^{P}, and R^{N} is independently a (C₁-C₃₀)hydrocarbyl, (C₁-C₃₀)heterohydrocarbyl, or —H.

### BRIEF DESCRIPTION OF THE DRAWINGS

FIG. 1 is a chart of the catalyst efficiency of bis-phenylphenoxy 4 (BPP-4) and BPP-11 as a function of MMAO.

FIG. 2 is a chart of the catalyst efficiency of BPP-2 and BPP-4 as a function of MMAO.

FIG. 3 is a chart of the catalyst efficiency of BPP-1 to BPP-6 and BPP-12 as a function of MMAO.

FIG. 4 is a chart of the catalyst efficiency of BPP-9 and BPP-10 as a function of MMAO.

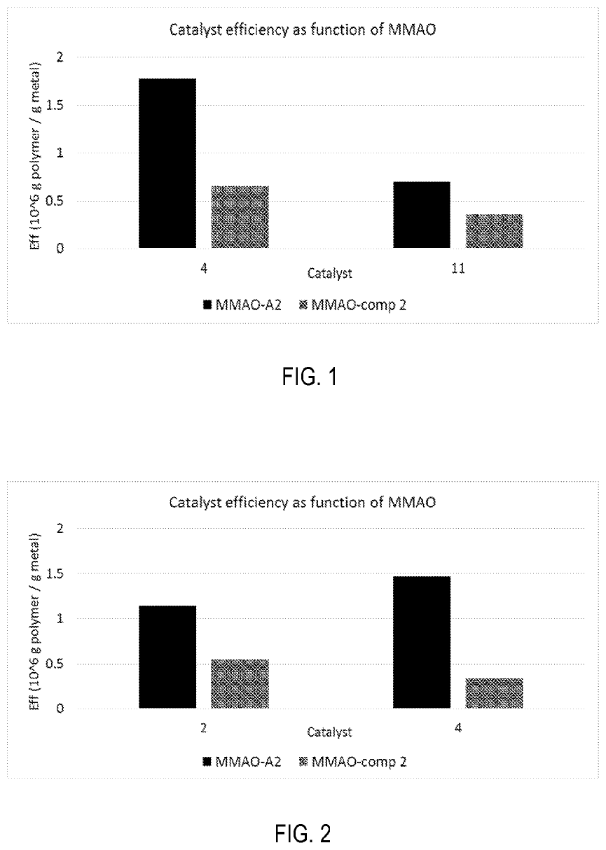

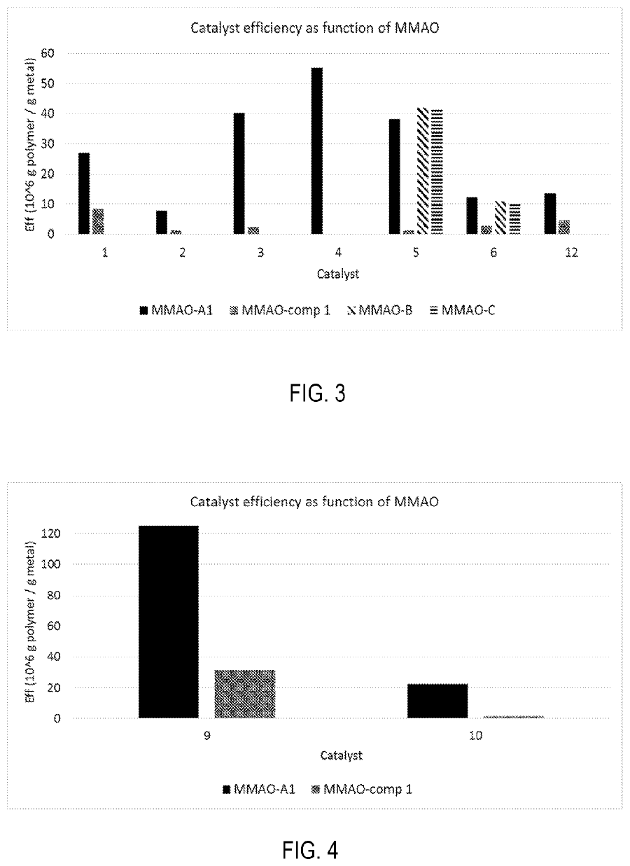

### DETAILED DESCRIPTION

Specific embodiments of catalyst systems will now be described. It should be understood that the catalyst systems of this disclosure may be embodied in different forms and should not be construed as limited to the specific embodiments set forth in this disclosure. Rather, embodiments are provided so that this disclosure will be thorough and complete, and will fully convey the scope of the subject matter to those skilled in the art.

Common abbreviations are listed below:

Me: methyl; Et: ethyl; Ph: phenyl; Bn: benzyl; i-Pr: iso-propyl; t-Bu: tert-butyl; t-Oct: tert-octyl (2,4,4-trimethylpentan-2-yl); Tf: trifluoromethane sulfonate; THF: tetrahydrofuran; Et₂O: diethyl ether; CH₂Cl₂: dichloromethane; CV: column volume (used in column chromatography); EtOAc: ethyl acetate; C₆D₆: deuterated benzene or benzene-d6 CDCl₃: deuterated chloroform; Na₂SO₄: sodium sulfate; MgSO₄: magnesium sulfate; HCl hydrogen chloride; n-BuLi: n-butyllithium; t-BuLi: tert-butyllithium; MAO methylaluminoxane; MMAO: modified methylaluminoxane; GC: gas chromatography; LC liquid chromatography; NMR: nuclear magnetic resonance; MS: mass spectrometry; mmol millimoles; mL: milliliters; M: molar; min or mins: minutes; h or hrs: hours; d: days.

The term “independently selected” is used herein to indicate that the R groups, such as, R¹, R², R³, R⁴, and R⁵, can be identical or different (e.g., R¹, R², R³, R⁴, and R⁵ may all be substituted alkyls or R¹ and R² may be a substituted alkyl and R³ may be an aryl, etc). A chemical name associated with an R group is intended to convey the chemical structure that is recognized in the art as corresponding to that of the chemical name. Thus, chemical names are intended to supplement and illustrate, not preclude, the structural definitions known to those of skill in the art.

The term “procatalyst” refers to a transition metal compound that has olefin polymerization catalytic activity when combined with an activator. The term “activator” refers to a compound that chemically reacts with a procatalyst in a manner that converts the procatalyst to a catalytically active catalyst. As used herein, the terms “co-catalyst” and “activator” are interchangeable terms.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₅₀)alkyl is an alkyl group having from 1 to 50 carbon atoms in its unsubstituted form. In some embodiments and general structures, certain chemical groups may be substituted by one or more substituents such as R^{S}. An R^{S} substituted chemical group defined using the “(Cₓ-C_{y})” parenthetical may contain more than y carbon atoms depending on the identity of any groups R^{S}. For example, a “(C₁-C₅₀)alkyl substituted with exactly one group R^{S}, where R^{S} is phenyl (—C₆H₅)” may contain from 7 to 56 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “substitution” means that at least one hydrogen atom (—H) bonded to a carbon atom of a corresponding unsubstituted compound or functional group is replaced by a substituent (e.g. R^{S}). The term “—H” means a hydrogen or hydrogen radical that is covalently bonded to another atom. “Hydrogen” and “—H” are interchangeable, and unless clearly specified have identical meanings.

The term “(C₁-C₅₀)alkyl” means a saturated straight or branched hydrocarbon radical containing from 1 to 50 carbon atoms; and the term “(C₁-C₃₀)alkyl” means a saturated straight or branched hydrocarbon radical of from 1 to 30 carbon atoms. Each (C₁-C₅₀)alkyl and (C₁-C₃₀)alkyl may be unsubstituted or substituted by one or more R^{S}. In some examples, each hydrogen atom in a hydrocarbon radical may be substituted with R^{S}, such as, for example trifluoromethyl. Examples of unsubstituted (C₁-C₅₀)alkyl are unsubstituted (C₁-C₂₀)alkyl; unsubstituted (C₁-C₁₀)alkyl; unsubstituted (C₁-C₅)alkyl; methyl; ethyl; 1-propyl; 2-propyl; 1-butyl; 2-butyl; 2-methylpropyl; 1,1-dimethylethyl; 1-pentyl; 1-hexyl; 1-heptyl; 1-nonyl; and 1-decyl. Examples of substituted (C₁-C₄₀)alkyl are substituted (C₁-C₂₀)alkyl, substituted (C₁-C₁₀)alkyl, trifluoromethyl, and [C₄₅]alkyl. The term “[C₄₅]alkyl” means there is a maximum of 45 carbon atoms in the radical, including substituents, and is, for example, a (C₂₇-C₄₀)alkyl substituted by one R^{S}, which is a (C₁-C₅)alkyl, such as, for example, methyl, trifluoromethyl, ethyl, 1-propyl, 1-methylethyl, or 1,1-dimethylethyl.

The term (C₃-C₅₀)alkenyl means a branched or unbranched, cyclic or acyclic monovalent hydrocarbon radical containing from 3 to 50 carbon atoms, at least one double bond and is unsubstituted or substituted by one or more R^{S}. Examples of unsubstituted (C₃-C₅₀)alkenyl: n-propenyl, isopropenyl, n-butenyl, isobutenyl, octenyl, decenyl, cyclopentenyl, cyclopentadienyl, cyclohexenyl, and cyclohexadienyl. Examples of substituted (C₃-C₅₀)alkenyl: (2-trifluoromethyl)pent-1-enyl, (3-methyl)hex-1-eneyl, (3-methyl)hexa-1,4-dienyl and (Z)-1-(6-methylhept-3-en-1-yl)cyclohex-1-eneyl.

The term “(C₃-C₅₀)cycloalkyl” means a saturated cyclic hydrocarbon radical of from 3 to 50 carbon atoms that is unsubstituted or substituted by one or more R^{S}. Other cycloalkyl groups (e.g., (Cₓ-C_{y})cycloalkyl) are defined in an analogous manner as having from x to y carbon atoms and being either unsubstituted or substituted with one or more R^{S}. Examples of unsubstituted (C₃-C₄₀)cycloalkyl are unsubstituted (C₃-C₂₀)cycloalkyl, unsubstituted (C₃-C₁₀)cycloalkyl, cyclopropyl, cyclobutyl, cyclopentyl, cyclohexyl, cycloheptyl, cyclooctyl, cyclononyl, and cyclodecyl. Examples of substituted (C₃-C₄₀)cycloalkyl are substituted (C₃-C₂₀)cycloalkyl, substituted (C₃-C₁₀)cycloalkyl, and 1-fluorocyclohexyl.

The term “halogen atom” or “halogen” means the radical of a fluorine atom (F), chlorine atom (Cl), bromine atom (Br), or iodine atom (I). The term “halide” means anionic form of the halogen atom: fluoride (F⁻), chloride (Cl⁻), bromide (Br⁻), or iodide (I⁻).

The term “saturated” means lacking carbon-carbon double bonds, carbon-carbon triple bonds, and (in heteroatom-containing groups) carbon-nitrogen, carbon-phosphorous, and carbon-silicon double bonds. Where a saturated chemical group is substituted by one or more substituents R^{S}, one or more double or triple bonds optionally may be present in substituents R^{S}. The term “unsaturated” means containing one or more carbon-carbon double bonds or carbon-carbon triple bonds, or (in heteroatom-containing groups) one or more carbon-nitrogen double bonds, carbon-phosphorous double bonds, or carbon-silicon double bonds, not including double bonds that may be present in substituents R^{S}, if any, or in aromatic rings or heteroaromatic rings, if any.

The term “hydrocarbyl-modified methylalumninoxane” refers to a methylaluminoxane (MMAO) structure comprising an amount of trihydrocarbyl aluminum. The hydrocarbyl-modified methylaluminoxane includes a combination of a hydrocarbyl-modified methylaluminoxane matrix and trihydrocarbylaluminum. A total molar amount of aluminum in the hydrocarbyl-modified methylaluminoxane is composed of the aluminum contribution from the moles of aluminum from the hydrocarbyl-modified methylaluminoxane matrix and moles of aluminum from the trihydrocarbyl aluminum. The hydrocarbyl-modified methylaluminoxane includes greater than 2.5 mole percent of trihydrocarbylaluminum based on the total moles of aluminum in the hydrocarbyl-modified methylaluminoxane. These additional hydrocarbyl substituents can impact the subsequent aluminoxane structure and result in differences in the distribution and size of aluminoxane clusters (Bryliakov, K. P et. al. Macromol. Chem. Phys. 2006, 207, 327-335). The additional hydrocarbyl substituents can also impart increased solubility of the aluminoxane in hydrocarbon solvents such as, but not limited to, hexane, heptane, methylcyclohexane, and ISOPAR Elm as demonstrated in U.S. Pat. No. 5,777,143. Modified methylaluminoxane compositions are generically disclosed and can be prepared as described in U.S. Pat. Nos. 5,066,631 and 5,728,855, both of which are incorporated herein by reference.

Embodiments of this disclosure includes processes of polymerizing olefin monomers. In one or more embodiments, the process includes reacting ethylene and optionally one or more olefin monomers in the presence of a catalyst system.

In some embodiments, the olefin monomer is (C₃-C₂₀)α-olefin. In other embodiments, the olefin monomer is not (C₃-C₂₀)α-olefin. In various embodiments, the olefin monomer is cyclic olefin.

In one or more embodiments, the catalyst system includes hydrocarbyl-modified methylaluminoxane and a metal-ligand complex. The hydrocarbyl-modified methylaluminoxane having less than 25 mole percent trihydrocarbyl aluminum based on the total moles of aluminum in the hydrocarbyl-modified methylaluminoxane. The trihydrocarbyl aluminum has a formula of AlR^{A1}R^{B1}R^{C1}, where R^{A1}, R^{B1}, and R^{C1} are independently (C₁-C₄₀)alkyl.

In embodiments, the hydrocarbyl-modified methylaluminoxane in the polymerization process has less than 20 mole percent and greater than 5 mole percent of trihydrocarbyl aluminum based on the total moles of aluminum in the hydrocarbyl-modified methylaluminoxane. In some embodiments, the hydrocarbyl-modified methylaluminoxane has less than 15 mole percent of trihydrocarbyl aluminum based on the total moles of aluminum in the hydrocarbyl-modified methylaluminoxane. In one or more embodiments, the hydrocarbyl-modified methylaluminoxane has less than 10 mole percent of trihydrocarbyl aluminum based on the total moles of aluminum in the hydrocarbyl-modified methylaluminoxane. In various embodiments, the hydrocarbyl-modified methylaluminoxane is modified methylaluminoxane.

In some embodiments, the trihydrocarbyl aluminum has a formula of AlR^{A1}R^{B1}R^{C1}, where R^{A1}, R^{B1}, and R^{C1} are independently (C₁-C₁₀)alkyl. In one or more embodiments, R^{A1}, R^{B1} and R^{C1} are independently methyl, ethyl, propyl, 2-propyl, butyl, tert-butyl, or octyl. In some embodiment, R^{A1}, R^{B1}, and R^{C1} are the same. In other embodiments, at least one of R^{A1}, R^{B1}, and R^{C1} is different from the other R^{A1}, R^{B1}, and R^{C1}.

In embodiments, the catalyst system includes hydrocarbyl-modified methylaluminoxane and a metal-ligand complex. In some embodiments, the catalyst system includes one or more metal-ligand complexes according to formula (I):

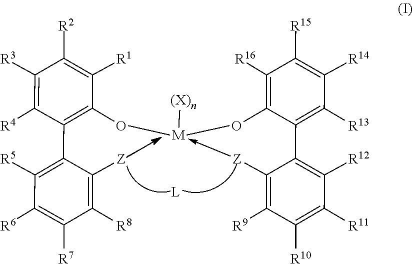

In formula (I), M is titanium, zirconium, hafnium, scandium, yttrium, or an element of the lanthanide series of the periodic table having a formal oxidation state of +2, +3, or +4. In some embodiments, M is Zr or Sc.

Subscript n of (X)ₙ is 1, 2, or 3. Each X is a monodentate ligand independently chosen from unsaturated (C₂-C₅₀)hydrocarbon, unsaturated (C₂-C₅₀)heterohydrocarbon, saturated (C₂-C₅₀)heterohydrocarbon, (C₁-C₅₀)hydrocarbyl, (C₆-C₅₀)aryl, (C₆-C₅₀)heteroaryl, cyclopentadienyl, substituted cyclopentadienyl, (C₄-C₁₂)diene, halogen, —N(R^{N})₂, and —N(R^{N})COR^{C}. The metal-ligand complex is overall charge-neutral. Each Z is independently chosen from —O—, —S—, —N(R^{N})—, or —P(R^{P})—. L is (C₁-C₄₀)hydrocarbylene or (C₂-C₄₀)heterohydrocarbylene.

In formula (I), R², R³, R⁴, R⁵, R⁶, R⁷, R⁸, R⁹, R¹⁰, R¹¹, R¹², R¹³, R¹⁴, and R¹⁵ are independently selected from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R)—, (R^{C})₂NC(O)—, and halogen.

In formula (I), R¹ and R¹⁶ are independently selected from the group consisting of —H, (C₁-C₄₀)hydrocarbyl, (C₁-C₄₀)heterohydrocarbyl, —Si(R^{C})₃, —Ge(R^{C})₃, P(R^{P})₂, —N(R^{N})₂, —OR^{C}, —SR^{C}, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, halogen, radicals having formula (II), radicals having formula (III), and radicals having formula (IV):

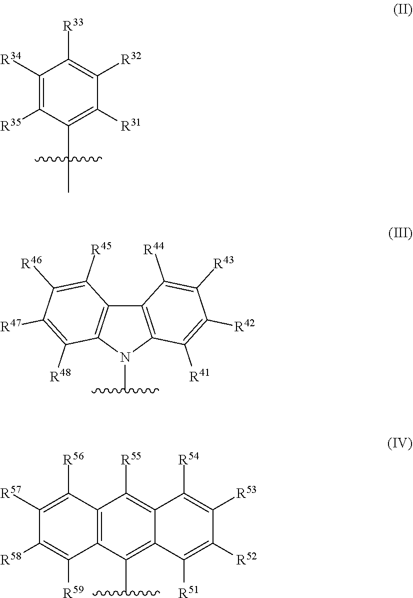

When present in the metal-ligand complex of formula (I) as part of a radical having formula (II), formula (III), or formula (IV), the groups R³¹⁻³⁵, R⁴¹⁻⁴⁸, and R⁵¹⁻⁵⁹ of the metal-ligand complex of formula (I) are each independently chosen from (C₁-C₄₀)hydrocarbyl, (C₁-C₄₀)heterohydrocarbyl, —Si(R^{C})₃, P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{N})₂NC(O)—, halogen, hydrogen (—H), or combinations thereof. Independently each R^{C}, R^{P}, and R^{N} are unsubstituted (C₁-C₁₈)hydrocarbyl, (C₁-C₃₀)heterohydrocarbyl, or —H.

In formulas (I), (II), (III), and (IV), each R^{C}, R^{P}, and R^{N} is independently a (C₁-C₃₀)hydrocarbyl, (C₁-C₃₀)heterohydrocarbyl, or —H.

In one or more embodiments, the metal-ligand complex of formula (I) is a procatalyst.

In some embodiments, the groups R¹ and R¹⁶ in the metal-ligand complex of formula (I) are chosen independently of one another. For example, R¹ may be chosen from a radical having formula (II), (III), or (IV) and R¹⁶ may be a (C₁-C₄₀)hydrocarbyl; or R¹ may be chosen from a radical having formula (II), (III), or (IV) and R¹⁶ may be chosen from a radical having formula (II), (III), or (IV) the same as or different from that of R¹. Both R¹ and R¹⁶ may be radicals having formula (II), for which the groups R³¹⁻³⁵ are the same or different in R¹ and R¹⁶. In other examples, both R¹ and R¹⁶ may be radicals having formula (III), for which the groups R⁴¹⁻⁴⁸ are the same or different in R¹ and R¹⁶; or both R¹ and R¹⁶ may be radicals having formula (IV), for which the groups R⁵¹⁻⁵⁹ are the same or different in R¹ and R¹⁶.

In some embodiments, at least one of R¹ and R¹⁶ is a radical having formula (II), where R³² and R³⁴ are tert-butyl. In one or more embodiments, R³² and R³⁴ are (C₁-C₁₂)hydrocarbyl or —Si[(C₁-C₁₀)alkyl]₃.

In some embodiments, when at least one of R¹ or R¹⁶ is a radical having formula (III), one of or both of R⁴³ and R⁴⁶ is tert-butyl and R⁴¹⁻⁴², R⁴⁴⁻⁴⁵, and R⁴⁷⁻⁴⁸ are —H. In other embodiments, one of or both of R⁴² and R⁴⁷ is tert-butyl and R⁴¹, R⁴³⁻⁴⁶, and R⁴⁷⁻⁴⁸ are —H. In some embodiments, both R⁴² and R⁴⁷ are —H. In various embodiments, R⁴² and R⁴⁷ are (C₁-C₂₀)hydrocarbyl or —Si[(C₁-C₁₀)alkyl]₃. In other embodiments, R⁴³ and R⁴⁶ are (C₁-C₂₀)hydrocarbyl or —Si(C₁-C₁₀)alkyl]₃.

In embodiments, when at least one of R¹ or R¹⁶ is a radical having formula (IV), each R⁵², R⁵³, R⁵⁵, R⁵⁷, and R⁵⁸ are —H, (C₁-C₂₀)hydrocarbyl, —Si[(C₁-C₂₀)hydrocarbyl]3, or —Ge[(C₁-C₂₀)hydrocarbyl]3. In some embodiments, at least one of R⁵², R⁵³, R⁵⁵, R⁵⁷, and R⁵⁸ is (C₃-C₁₀)alkyl, —Si[(C₃-C₁₀)alkyl]₃, or —Ge[(C₃-C₁₀)alkyl]₃. In one or more embodiments, at least two of R⁵², R⁵³, R⁵⁵, R⁵⁷, and R⁵⁸ is a (C₃-C₁₀)alkyl, —Si[(C₃-C₁₀)alkyl]₃, or —Ge[(C₃-C₁₀)alkyl]₃. In various embodiments, at least three of R⁵², R⁵³, R⁵⁵, R⁵⁷, and R⁵⁸ is a (C₃-C₁₀)alkyl, —Si[(C₃-C₁₀)alkyl]₃, or —Ge[(C₃-C₁₀)alkyl]₃.

In some embodiments, when at least one of R¹ or R¹⁶ is a radical having formula (IV), at least two of R⁵², R⁵³, R⁵⁵, R⁵⁷, and R⁵⁸ are (C₁-C₂₀)hydrocarbyl or —Si[(C₁-C₂₀)hydrocarbyl]3.

Examples of (C₃-C₁₀)alkyl include, but are not limited to: 1-propyl, 2-propyl (also called iso-propyl), 1,1-dimethylethyl (also called tert-butyl), cyclopentyl, cyclohexyl, 1-butyl, pentyl, 3-methylbutyl, hexyl, 4-methylpentyl, heptyl, n-octyl, tert-octyl (also called 2,4,4-trimethylpentan-2-yl), nonyl, and decyl.

In formula (I), R², R³, R⁴, R⁵, R⁶, R⁷, R⁸, R⁹, R¹⁰, R¹¹, R¹², R¹³, R¹⁴, and R¹⁵ is independently selected from —H, (C₁-C₄₀)hydrocarbyl, (C₁-C₄₀)heterohydrocarbyl, —Si(R^{C})₃, —Ge(R^{C})₃, P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R)—, (R^{C})₂NC(O)—, and halogen.

In one or more embodiments, R², R⁴, R⁵, R¹², R¹³, and R¹⁵ are hydrogen; and each Z is oxygen.

In various embodiments, at least one of R⁵, R⁶, R⁷, and R⁸ is a halogen atom; and at least one of R⁹, R¹⁰, R₁, and R¹² is a halogen atom. In some embodiments, R⁸ and R⁹ are independently (C₁-C₄)alkyl.

In some embodiments, R³ and R¹⁴ are (C₁-C₂₀)alkyl. In one or more embodiments, R³ and R¹⁴ are methyl and R⁶ and R¹¹ are halogen. In embodiments, R⁶ and R¹¹ are tert-butyl. In other embodiments, R³ and R¹⁴ are tert-octyl or n-octyl.

In various embodiments, R³ and R¹⁴ are (C₁-C₂₄)alkyl. In one or more embodiments, R³ and R¹⁴ are (C₄-C₂₄)alkyl. In some embodiments, R³ and R¹⁴ are 1-propyl, 2-propyl (also called iso-propyl), 1,1-dimethylethyl (also called tert-butyl), cyclopentyl, cyclohexyl, 1-butyl, pentyl, 3-methyl-1-butyl, hexyl, 4-methyl-L-pentyl, heptyl, n-octyl, tert-octyl (also called 2,4,4-trimethylpentan-2-yl), nonyl, and decyl. In embodiments, R³ and R¹⁴ are —OR^{C}, wherein R^{C} is (C₁-C₂₀)hydrocarbon, and in some embodiments, R^{C} is methyl, ethyl, 1-propyl, 2-propyl (also called iso-propyl), or 1,1-dimethylethyl.

In one or more embodiments, one of R⁸ and R⁹ is not —H. In various embodiments, at least one of R⁸ and R⁹ is (C₁-C₂₄)alkyl. In some embodiments, both R⁸ and R⁹ are (C₁-C₂₄)alkyl. In some embodiments, R⁸ and R⁹ are methyl. In other embodiments, R⁸ and R⁹ are halogen.

In some embodiments, R³ and R¹⁴ are methyl; In one or more embodiments, R³ and R₁₄ are (C₄-C₂₄)alkyl. In some embodiments, R³ and R¹⁴ are 1-propyl, 2-propyl (also called iso-propyl), 1,1-dimethylethyl (also called tert-butyl), cyclopentyl, cyclohexyl, 1-butyl, pentyl, 3-methyl-1-butyl, hexyl, 4-methyl-1-pentyl, heptyl, n-octyl, tert-octyl (also called 2,4,4-trimethylpentan-2-yl), nonyl, and decyl.

In various embodiments, in the metal-ligand complex of formula (I), R⁶ and R¹¹ are halogen. In some embodiments, R⁶ and R¹¹ are (C₁-C₂₄)alkyl. In various embodiments, R⁶ and R¹¹ independently are chosen from methyl, ethyl, 1-propyl, 2-propyl (also called iso-propyl), 1,1-dimethylethyl (also called tert-butyl), cyclopentyl, cyclohexyl, 1-butyl, n-pentyl, 3-methylbutyl, n-hexyl, 4-methylpentyl, n-heptyl, n-octyl, tert-octyl (also called 2,4,4-trimethylpentan-2-yl), nonyl, and decyl. In some embodiments, R⁶ and R¹¹ are tert-butyl. In embodiments, R⁶ and R¹¹ are —OR^{C}, wherein R^{C} is (C₁-C₂₀)hydrocarbyl, and in some embodiments, R^{C} is methyl, ethyl, 1-propyl, 2-propyl (also called iso-propyl), or 1,1-dimethylethyl. In other embodiments, R⁶ and R¹¹ are —SiR^{C}₃, wherein each R^{C} is independently (C₁-C₂₀)hydrocarbyl, and in some embodiments, R^{C} is methyl, ethyl, 1-propyl, 2-propyl (also called iso-propyl), or 1,1-dimethylethyl.

In some embodiments, any or all of the chemical groups (e.g., X and R¹⁻⁵⁹) of the metal-ligand complex of formula (I) may be unsubstituted. In other embodiments, none. any, or all of the chemical groups X and R¹⁻⁵⁹ of the metal-ligand complex of formula (I) may be substituted with one or more than one R^{S}. When two or more than two R^{S} are bonded to a same chemical group of the metal-ligand complex of formula (I), the individual R^{S} of the chemical group may be bonded to the same carbon atom or heteroatom or to different carbon atoms or heteroatoms. In some embodiments, none, any, or all of the chemical groups X and R¹⁻⁵⁹ may be persubstituted with R^{S}. In the chemical groups that are persubstituted with R^{S}, the individual R^{S} may all be the same or may be independently chosen. In one or more embodiments, R^{S} is chosen from (C₁-C₂₀)hydrocarbyl, (C₁-C₂₀)alkyl, (C₁-C₂₀)heterohydrocarbyl. or (C₁-C₂₀)heteroalkyl.

In formula (I), L is (C₁-C₄₀)hydrocarbylene or (C₁-C₄₀)heterohydrocarbylene; and each Z is independently chosen from —O—, —S—, —N(R^{N})—, or —P(R^{P})—. In one or more embodiments, L includes from 1 to 10 atoms.

In formulas (I), (II), (III), and (IV), each R^{C}, R^{P}, and R^{N} is independently a (C₁-C₃₀)hydrocarbyl, (C₁-C₃₀)heterohydrocarbyl, or —H.

In some embodiments of formula (I), the L may be chosen from (C₃-C₇)alkyl 1,3-diradicals, such as —CH₂CH₂CH₂—, —CH(CH₃)CH₂C*H(CH₃), —CH(CH₃)CH(CH₃)C*H(CH₃), —CH₂C(CH₃)₂CH₂—, cyclopentan-1,3-diyl, or cyclohexan-1,3-diyl, for example. In some embodiments, the L may be chosen from (C₄-C₁₀)alkyl 1,4-diradicals, such as —CH₂CH₂CH₂CH₂—, —CH₂C(CH₃)₂C(CH₃)₂CH₂—, cyclohexane-1,2-diyldimethyl, and bicyclo[2.2.2]octane-2,3-diyldimethyl, for example. In some embodiments, L may be chosen from (C₅-C₁₂)alkyl 1,5-diradicals, such as —CH₂CH₂CH₂CH₂CH₂—, and 1,3-bis(methylene)cyclohexane. In some embodiments, L may be chosen from (C₆-C₁₄)alkyl 1,6-diradicals, such as —CH₂CH₂CH₂CH₂CH₂CH₂— or 1,2-bis(ethylene)cyclohexane, for example.

In one or more embodiments, L is (C₂-C₄₀)heterohydrocarbylene. In some embodiments, L is —CH₂Ge(R^{C})₂CH₂—, where each R^{C} is (C₁-C₃₀)hydrocarbyl. In some embodiments, L is —CH₂Ge(CH₃)₂CH₂—, —CH₂Ge(ethyl)₂CH₂—, —CH₂Ge(2-propyl)₂CH₂—, —CH₂Ge(t-butyl)₂CH₂—, —CH₂Ge(cyclopentyl)₂CH₂—, or —CH₂Ge(cyclohexyl)₂CH₂—.

In one or more embodiments, L is chosen from —CH₂—; —CH₂CH₂—; —CH₂(CH₂)ₘCH₂—, CH₂(C(H)R^{C})ₘCH₂— and —CH₂(CR^{C})ₘCH₂—, where subscript m is from 1 to 3; —CH₂Si(R^{C})₂CH₂—; —CH₂Ge(R^{C})₂CH₂—; —CH(CH₃)CH₂CH*(CH₃); and —CH₂(phen-1,2-di-yl)CH₂—; where each R^{C} in L is (C₁-C₂₀)hydrocarbyl.

Examples of such (C₁-C₁₂)alkyl include, but are not limited to methyl, ethyl, 1-propyl, 2-propyl (also called iso-propyl), 1,1-dimethylethyl, cyclopentyl, or cyclohexyl, butyl, tert-butyl, pentyl, hexyl, heptyl, n-octyl, tert-octyl (also called 2,4,4-trimethylpent-2-yl), nonyl, decyl, undecyl, and dodecyl.

In some embodiments, in the metal-ligand complex according to formula (I), both R⁸ and R⁹ are methyl. In other embodiments, one of R⁸ and R⁹ is methyl and the other of R⁸ and R⁹ is —H.

In the metal-ligand complex according to formula (I), X bonds with M through a covalent bond or an ionic bond. In some embodiments, X may be a monoanionic ligand having a net formal oxidation state of −1. Each monoanionic ligand may independently be hydride, (C₁-C₄₀)hydrocarbyl carbanion, (C₁-C₄₀)heterohydrocarbyl carbanion, halide, nitrate, carbonate, phosphate, sulfate, HC(O)O⁻, HC(O)N(H)⁻, (C₁-C₄₀)hydrocarbyl(O)O⁻, (C₁-C₄₀)hydrocarbylC(O)N((C₁-C₂₀)hydrocarbyl)⁻, (C₁-C₄₀)hydrocarbylC(O)N(H)⁻, R^{K}R^{L}B⁻, R^{K}R^{L}N⁻, R^{K}O⁻, R^{K}R^{L}P⁻, or R^{M}R^{K}R^{L}Si⁻, where each R^{K}, R^{L}, and R^{M} independently is hydrogen, (C₁-C₄₀)hydrocarbyl, or (C₁-C₄₀)heterohydrocarbyl, or R^{K} and R^{L} are taken together to form a (C₂-C₄₀)hydrocarbylene or (C₁-C₂₀)heterohydrocarbylene and R^{M} is as defined above.

In some embodiments, X is a halogen, unsubstituted (C₁-C₂₀)hydrocarbyl, unsubstituted (C₁-C₂₀)hydrocarbylC(O)O—, or R^{K}R^{L}N—, wherein each of R^{K} and R^{L} independently is an unsubstituted(C₁-C₂₀)hydrocarbyl. In some embodiments, each monodentate ligand X is a chlorine atom, (C₁-C₁₀)hydrocarbyl (e.g., (C₁-C₆)alkyl or benzyl), unsubstituted (C₁-C₁₀)hydrocarbylC(O)O—, or R^{K}R^{L}N—, wherein each of R^{K} and R^{L} independently is an unsubstituted (C₁-C₁₀)hydrocarbyl.

In further embodiments, X is selected from methyl; ethyl; 1-propyl; 2-propyl; 1-butyl; 2,2,-dimethylpropyl; trimethylsilylmethyl; phenyl; benzyl; or chloro. X is methyl; ethyl; 1-propyl; 2-propyl; 1-butyl; 2,2,-dimethylpropyl; trimethylsilylmethyl; phenyl; benzyl; and chloro. In one embodiment, n is 2 and at least two X independently are monoanionic monodentate ligands. In a specific embodiment, n is 2 and the two X groups join to form a bidentate ligand. In further embodiments, the bidentate ligand is 2,2-dimethyl-2-silapropane-1,3-diyl or 1,3-butadiene.

In one or more embodiments, each X is independently —(CH₂)SiR^{X}₃, in which each R^{X} is independently a (C₁-C₃₀)alkyl or a (C₁-C₃₀)heteroalkyl and at least one R^{X} is (C₁-C₃₀)alkyl. In some embodiments, when one of R^{X} is a (C₁-C₃₀)heteroalkyl, the heteroatom is silica or oxygen atom. In some embodiments, R^{X} is methyl, ethyl, propyl, 2-propyl, butyl, 1,1-dimethylethyl (or tert-butyl), pentyl, hexyl, heptyl, n-octyl, tert-octyl, or nonyl.

In one or more embodiments X is —(CH₂)Si(CH₃)₃, —(CH₂)Si(CH₃)₂(CH₂CH₃); —(CH₂)Si(CH₃)(CH₂CH₃)₂, —(CH₂)Si(CH₂CH₃)₃, —(CH₂)Si(CH₃)₂(n-butyl), —(CH₂)Si(CH₃)₂(n-hexyl), —(CH₂)Si(CH₃)(n-Oct)R^{X}, —(CH₂)Si(n-Oct)R^{X}₂, —(CH₂)Si(CH₃)₂(2-ethylhexyl), —(CH₂)Si(CH₃)₂(dodecyl), —CH₂Si(CH₃)₂CH₂Si(CH₃)₃ (herein referred to as —CH₂Si(CH₃)₂CH₂TMS). Optionally, in some embodiments, the metal-ligand complex according to formula (I), exactly two R^{X} are covalently linked or exactly three R^{X} are covalently linked.

In some embodiments, X is —CH₂Si(R^{C})_{3-Q}(OR^{C})_{Q}, Si(R^{C})_{3-Q}(OR^{C})_{Q}, —OSi(R^{C})_{3-Q}(OR^{C})_{Q}, in which subscript Q is 0, 1, 2 or 3 and each R^{C} is independently a substituted or unsubstituted (C₁-C₃₀)hydrocarbyl, or a substituted or unsubstituted (C₁-C₃₀)heterohydrocarbyl.

### Cocatalyst Component

The catalyst system comprising a metal-ligand complex of formula (I) may be rendered catalytically active by any technique known in the art for activating metal-based catalysts of olefin polymerization reactions. For example, the procatalyst according to a metal-ligand complex of formula (I) may be rendered catalytically active by contacting the complex to, or combining the complex with, an activating co-catalyst. Additionally, the metal-ligand complex according to formula (I) includes both a procatalyst form, which is neutral, and a catalytic form, which may be positively charged due to the loss of a monoanionic ligand, such as a methyl. benzyl or phenyl. Suitable activating co-catalysts for use herein include oligomeric alumoxanes or hydrocarbyl-modified methylaluminoxanes.

In embodiments, the catalyst system does not contain a borate activator. In one or more embodiments, the borate activator is tetrakis(pentafluorophenyl)borate(1-) anion and a countercation. In some embodiments, the borate activator is bis(hydrogenated tallow alkyl)methylammonium tetrakis(pentafluorophenyl)borate.

### Polyolefins

The catalytic systems described in the preceding paragraphs are utilized in the polymerization of olefins, primarily ethylene and propylene, to form ethylene-based polymers or propylene-based polymers. In some embodiments, there is only a single type of olefin or α-olefin in the polymerization scheme, creating a homopolymer. However, additional α-olefins may be incorporated into the polymerization procedure. The additional α-olefin co-monomers typically have no more than 20 carbon atoms. For example, the α-olefin co-monomers may have 3 to 10 carbon atoms or 3 to 8 carbon atoms. Exemplary α-olefin co-monomers include, but are not limited to, propylene, 1-butene, 1-pentene, 1-hexene, 1-heptene, 1-octene, 1-nonene, 1-decene, and 4-methyl-1-pentene. For example, the one or more α-olefin co-monomers may be selected from the group consisting of propylene, 1-butene, I-hexene, and 1-octene; or in the alternative, from the group consisting of 1-hexene and 1-octene.

The ethylene-based polymers, for example homopolymers and/or interpolymers (including copolymers) of ethylene and optionally one or more co-monomers such as α-olefins, may comprise from at least 50 mole percent (mol %) monomer units derived from ethylene. All individual values and subranges encompassed by “from at least 50 mole percent” are disclosed herein as separate embodiments; for example, the ethylene based polymers, homopolymers and/or interpolymers (including copolymers) of ethylene and optionally one or more co-monomers such as α-olefins may comprise at least 60 mole percent monomer units derived from ethylene; at least 70 mole percent monomer units derived from ethylene; at least 80 mole percent monomer units derived from ethylene; or from 50 to 100 mole percent monomer units derived from ethylene; or from 80 to 100 mole percent monomer units derived from ethylene.

In some embodiments, the ethylene-based polymers may comprise at least 90 mole percent units derived from ethylene. All individual values and subranges from at least 90 mole percent are included herein and disclosed herein as separate embodiments. For example, the ethylene based polymers may comprise at least 93 mole percent units derived from ethylene; at least 96 mole percent units; at least 97 mole percent units derived from ethylene; or in the alternative, from 90 to 100 mole percent units derived from ethylene; from 90 to 99.5 mole percent units derived from ethylene; or from 97 to 99.5 mole percent units derived from ethylene.

In some embodiments of the ethylene-based polymer, the amount of additional α-olefin is less than 50 mol %; other embodiments include at least 1 mole percent (mol %) to 25 mol %; and in further embodiments the amount of additional α-olefin includes at least 5 mol % to 100 mol %. In some embodiments, the additional α-olefin is 1-octene.

Any conventional polymerization processes may be employed to produce the ethylene based polymers. Such conventional polymerization processes include, but are not limited to, solution polymerization processes, slurry phase polymerization processes, and combinations thereof using one or more conventional reactors such as loop reactors, isothermal reactors, stirred tank reactors, batch reactors in parallel, series, or any combinations thereof, for example.

In one embodiment, the ethylene-based polymer may be produced via solution polymerization in a dual reactor system, for example a dual loop reactor system, wherein ethylene and optionally one or more α-olefins are polymerized in the presence of the catalyst system, as described herein, and optionally one or more co-catalysts. In another embodiment, the ethylene based polymer may be produced via solution polymerization in a dual reactor system, for example a dual loop reactor system, wherein ethylene and optionally one or more α-olefins are polymerized in the presence of the catalyst system in this disclosure, and as described herein, and optionally one or more other catalysts. The catalyst system, as described herein, can be used in the first reactor, or second reactor, optionally in combination with one or more other catalysts. In one embodiment, the ethylene based polymer may be produced via solution polymerization in a dual reactor system, for example a dual loop reactor system, wherein ethylene and optionally one or more α-olefins are polymerized in the presence of the catalyst system, as described herein, in both reactors.

In another embodiment, the ethylene based polymer may be produced via solution polymerization in a single reactor system, for example a single loop reactor system, in which ethylene and optionally one or more α-olefins are polymerized in the presence of the catalyst system, as described within this disclosure, and optionally one or more co-catalysts, as described in the preceding paragraphs.

The ethylene based polymers may further comprise one or more additives. Such additives include, but are not limited to, antistatic agents, color enhancers, dyes, lubricants, pigments, primary antioxidants, secondary antioxidants, processing aids, UV stabilizers, and combinations thereof. The ethylene based polymers may contain any amounts of additives. The ethylene based polymers may compromise from about 0 to about 10 percent by the combined weight of such additives, based on the weight of the ethylene based polymers and the one or more additives. The ethylene based polymers may further comprise fillers, which may include, but are not limited to, organic or inorganic fillers. The ethylene based polymers may contain from about 0 to about 20 weight percent fillers such as, for example, calcium carbonate, talc, or Mg(OH)₂, based on the combined weight of the ethylene based polymers and all additives or fillers. The ethylene based polymers may further be blended with one or more polymers to form a blend.

In some embodiments, a polymerization process for producing an ethylene-based polymer may include polymerizing ethylene and at least one additional α-olefin in the presence of a catalyst system according to the present disclosure. The polymer resulting from such a catalyst system that incorporates the metal-ligand complex of formula (I) may have a density according to ASTM D792 (incorporated herein by reference in its entirety) from 0.850 g/cm³ to 0.970 g/cm³, from 0.880 g/cm³ to 0.920 g/cm³, from 0.880 g/cm³ to 0.910 g/cm³, or from 0.880 g/cm³ to 0.900 g/cm³, from 0.950 g/cm³ to 0.965 g/cm³ for example.

In another embodiment, the polymer resulting from the catalyst system according to the present disclosure has a melt flow ratio (110/12) from 5 to 15, where the melt index, 12, is measured according to ASTM D1238 (incorporated herein by reference in its entirety) at 190° C. and 2.16 kg load, and melt index I₁₀ is measured according to ASTM D1238 at 190° C. and 10 kg load. In other embodiments the melt flow ratio (110/12) is from 5 to 10, and in others, the melt flow ratio is from 5 to 9.

In some embodiments, the polymer resulting from the catalyst system according to the present disclosure has a molecular-weight distribution (MWD) from 1 to 25, where MWD is defined as M_{w}/Mₙ with M_{w} being a weight-average molecular weight and Mₙ being a number-average molecular weight. In other embodiments, the polymers resulting from the catalyst system have a MWD from 1 to 6. Another embodiment includes a MWD from 1 to 3; and other embodiments include MWD from 1.5 to 2.5.

Embodiments of the catalyst systems described in this disclosure yield a catalyst system having a high efficiency in comparison to catalyst systems lacking the hydrocarbyl-modified methylaluminoxane.

One or more features of the present disclosure are illustrated in view of the examples as follows:

### EXAMPLES

Procedure for Continuous Process Reactor Polymerization: Raw materials (ethylene, 1-octene) and the process solvent (a narrow boiling range high-purity isoparaffinic solvent trademarked ISOPAR E commercially available from ExxonMobil Corporation) are purified with molecular sieves before introduction into the reaction environment. Hydrogen is supplied in pressurized cylinders as a high purity grade and is not further purified. The reactor monomer feed (ethylene) stream is pressurized to above reaction pressure. The solvent and comonomer feed is pressurized to above reaction pressure. The individual catalyst components (metal ligand complex and cocatalysts) are manually batch diluted to specified component concentrations with purified solvent and pressured to above reaction pressure. All reaction feed flows are measured with mass flow meters and independently controlled with computer automated valve control systems.

The continuous solution polymerizations are carried out in a continuously stirred-tank reactor (CSTR). The combined solvent, monomer, comonomer and hydrogen feed to the reactor is temperature controlled between 5° C. and 50° C. and is typically 15-25° C. All of the components are fed to the polymerization reactor with the solvent feed. The catalyst is fed to the reactor to reach a specified conversion of ethylene. The cocatalyst component(s) is/are fed separately based on a calculated specified molar or ppm ratios. The effluent from the polymerization reactor (containing solvent, monomer, comonomer, hydrogen, catalyst components, and polymer) exits the reactor and is contacted with water. In addition, various additives such as antioxidants, can be added at this point. The stream then goes through a static mixer to evenly disperse the mixture.

Following additive addition, the effluent (containing solvent, monomer, comonomer, hydrogen, catalyst components, and molten polymer) passes through a heat exchanger to raise the stream temperature in preparation for separation of the polymer from the other lower-boiling components. The stream then passes through the reactor pressure control valve, across which the pressure is greatly reduced. From there, it enters a two stage separation system consisting of a devolatizer and a vacuum extruder, where solvent and unreacted hydrogen, monomer, comonomer, and water are removed from the polymer. At the exit of the extruder, the strand of molten polymer formed goes through a cold-water bath, where it solidifies. The strand is then fed through a strand chopper, where the polymer is cut it into pellets after being air-dried.

Procedure for Batch Reactor Polymerization. Raw materials (ethylene, 1-octene) and the process solvent (ISOPAR E) are purified with molecular sieves before introduction into the reaction environment. A stirred autoclave reactor was charged with ISOPAR E, and 1-octene. The reactor was then heated to a temperature and charged with ethylene to reach a pressure. Optionally, hydrogen was also added. The catalyst system was prepared in a drybox under inert atmosphere by mixing the metal-ligand complex and optionally one or more additives, with additional solvent. The catalyst system was then injected into the reactor. The reactor pressure and temperature were kept constant by feeding ethylene during the polymerization and cooling the reactor as needed. After 10 minutes, the ethylene feed was shut off and the solution transferred into a nitrogen-purged resin kettle. The polymer was thoroughly dried in a vacuum oven, and the reactor was thoroughly rinsed with hot ISOPAR E between polymerization runs.

Test Methods

Unless otherwise indicated herein, the following analytical methods are used in describing aspects of the present disclosure:

Melt Index

Melt indices I₂ (or I₂) and I₁₀ (or I10) of polymer samples were measured in accordance to ASTM D-1238 (method B) at 190° C. and at 2.16 kg and 10 kg load, respectively. Their values are reported in g/10 min.

Density

Samples for density measurement were prepared according to ASTM D4703. Measurements were made, according to ASTM D792, Method B, within one hour of sample pressing.

Gel Permeation Chromatography (GPC)

The chromatographic system consisted of a PolymerChar GPC-IR (Valencia, Spain) high temperature GPC chromatograph equipped with an internal IR5 infra-red detector (IR5). The autosampler oven compartment was set at 160° Celsius and the column compartment was set at 150° Celsius. The columns used were 4 Agilent “Mixed A” 30 cm 20-micron linear mixed-bed columns and a 20-um pre-column. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)).:

M_{polyethylene}=A×(M_{polystyrene})^{B} (EQ 1)

where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects such that linear homopolymer polyethylene standard is obtained at 120,000 Mw.

The total plate count of the GPC column set was performed with decane (prepared at 0.04 g in 50 milliliters of TCB and dissolved for 20 minutes with gentle agitation.) The plate count (Equation 2) and symmetry (Equation 3) were measured on a 200 microliter injection according to the following equations:

$$Plate Count = 5.54 * {( \frac{( {RV}_{Peak Max}}{Peak Width at \frac{1}{2} height} )}^{2} \qquad ( EQ 2 )$$

where RV is the retention volume in milliliters, the peak width is in milliliters, the peak max is the maximum height of the peak, and ½ height is ½ height of the peak maximum.

$$Symmetry = \frac{( Rear Peak {RV}_{one tenth height} - {RV}_{Peak max} )}{( {RV}_{Peak max} - Front Peak {RV}_{one tenth height} )} \qquad ( EQ 3 )$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 5 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ 6 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 7. Processing of the flow marker peak was done via the PolymerChar GPCOne™ Software. Acceptable flowrate correction is such that the effective flowrate should be within +/−0.5% of the nominal flowrate.

Flowrate(effective)=Flowrate(nominal)*(RV(FM Calibrated)/RV(FM Sample)) (EQ 7)

Analysis of Hydrocarbyl-Modified Methylaluminoxanes

Example 1 is the analytical procedure for determination of aluminum concentration in a solution.

In a nitrogen atmosphere glovebox, aluminum-based analyte having the formula AlR^{A1}R^{B1}R^{C1} was transferred to a tared bottle and the mass of the sample was recorded. The sample was diluted with methylcyclohexane and then quenched with methanol. The mixture was swirled and allowed to react over 15 minutes prior to removal of the sample from the glovebox. The sample was further hydrolyzed by addition of H₂SO₄. The bottle was capped shaken for five minutes. Periodic venting of the bottle may be necessary depending on aluminum concentration. The solution was transferred to a separatory funnel. The bottle was rinsed repeatedly with water adding each rinseate from this process to the separatory funnel. The organic layer was discarded and the remaining aqueous solution was transferred to a volumetric flask. The separatory funnel was further rinsed with water, each rinseate being added to the volumetric flask. The flask was diluted to a known volume, thoroughly mixed, and analyzed by complexation with excess EDTA and subsequent back-titration with ZnCl₂ using xylenol orange as an indicator.

Calculation of the AlR^{A1}R^{B1}R^{C1} Compound in the Hydrocarbyl-Modified Methylaluminoxane

$$Molarity Al in titrant = \frac{[ ( M EDTA * mL EDTA ) - ( M {ZnCl}_{2} * mL {ZnCl}_{2} )}{mL , aqueous solution used in titrated} \qquad ( 1 )$$

$$mole \% Al in sample = \frac{( \begin{matrix}Molarity Al in titrant * \\ Volume of Volumetric Dilution\end{matrix} ) * 26.98 \frac{g}{mol Al}}{Mass of Analyte Sample} * 100 \qquad ( 2 )$$

The AlR^{A}1R^{B1}R^{C1} Compound content is analyzed using previously described methods (Macromol. Chem. Phys. 1996, 197, 1537; WO2009029857A1; Analytical Chemistry 1968, 40 (14), 2150-2153; and Organometallics 2013, 32(11), 3354-3362)

The metal-complexes are conveniently prepared by standard metallation and ligand exchange procedures involving a source of transition metal and a neutral polyfunctional ligand source. In addition, the complexes may also be prepared by means of an amide elimination and hydrocarbylation process starting from the corresponding transition metal tetraamide and a hydrocarbylating agent, such as trimethylaluminum. The techniques employed are the same as of analogous to those disclosed in U.S. Pat. Nos. 6,320,005, 6,103,657, WO 02/38628, WO 03/40195, US-A-2004/0220050.

The synthetic procedures for synthesizing metal-ligand complexes 1 to 12 may be found in in the procedures below and, where previously disclosed, in the following publications US20040010103A1, WO2007136494A2, WO2012027448A1, WO2016003878A1, WO2016014749A1, WO2017058981A1, WO2018022975A1

The Bis-phenylphenoxy (BPP) Complexes BPP-1 to BPP-13 have a structure according to formula (I) and are as follows:

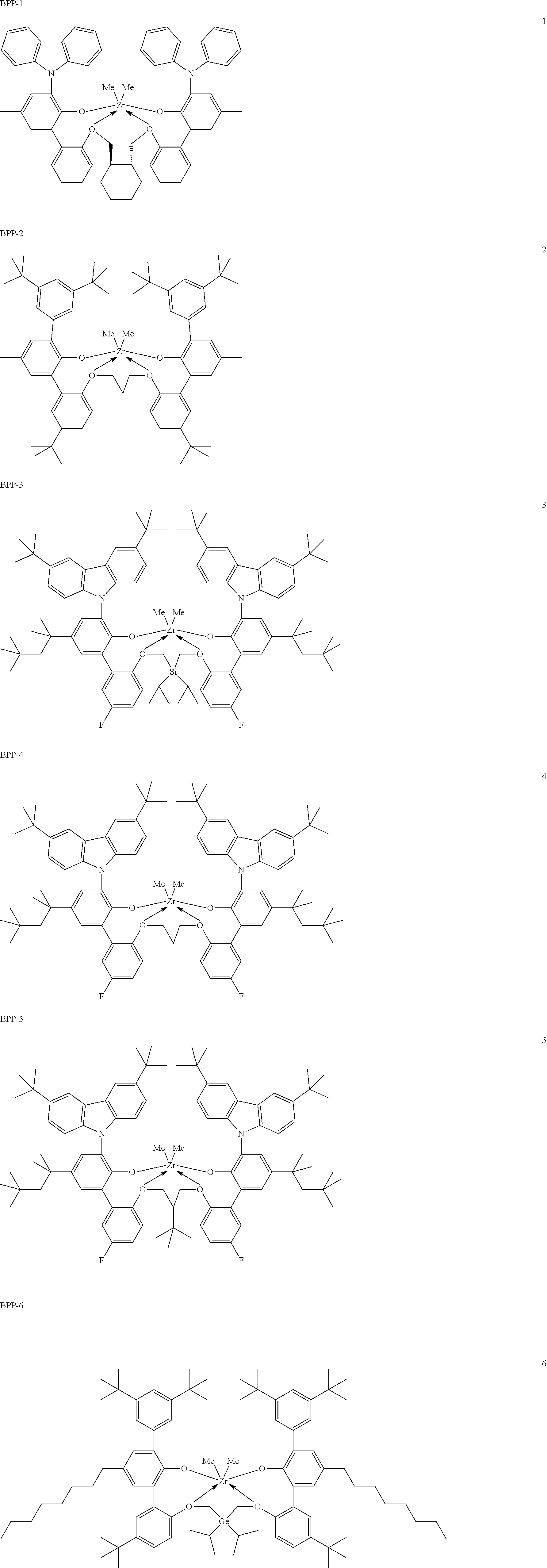

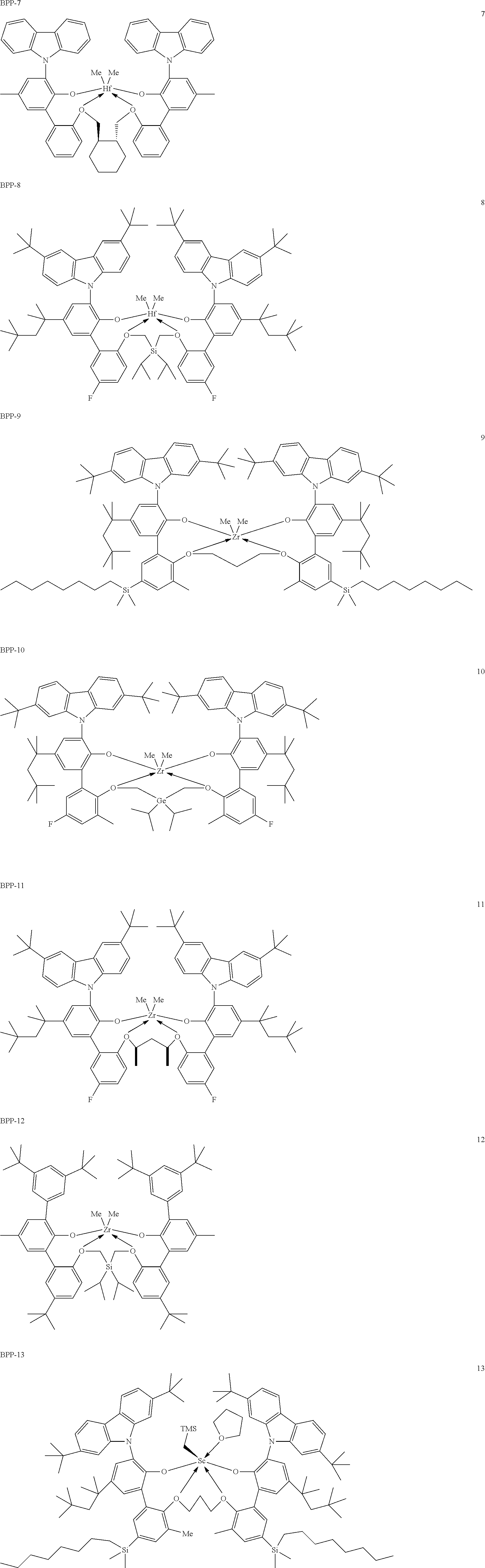

Preparation of BPP 3 (Ligand disclosed in WO2018022975 A1)

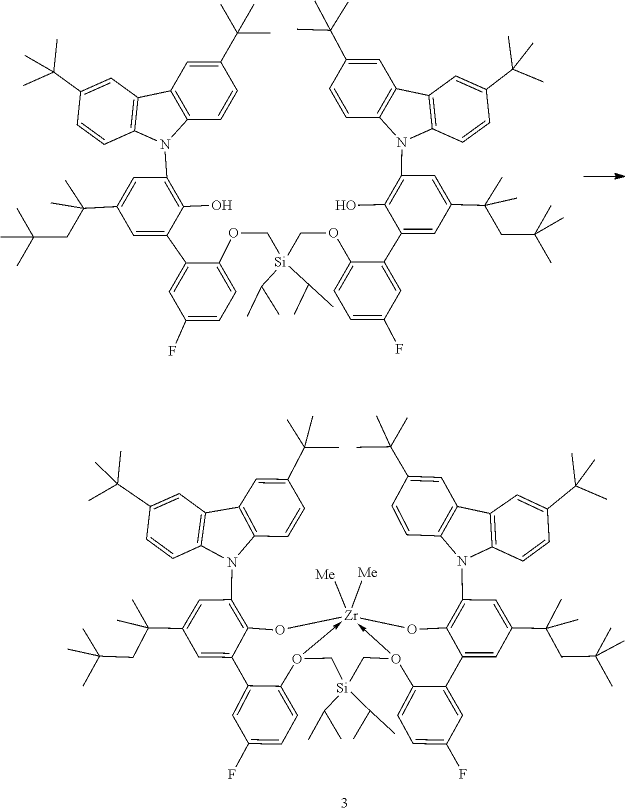

Synthesis of 6′,6′″-(((diisopropylsilanediyl)bis(methylene))bis(oxy))bis(3-(3,6-di-tert-butyl-9H-carbazol-9-yl)-3′-fluoro-5-(2,4,4-trimethylpentan-2-yl)-[1,1′-biphenyl]-2-ol)dimethyl-zirconium (BPP-3): MeMgBr in diethyl ether (3.00 M, 5.33 mL, 16.0 mmol) was added to a −30° C. solution of ZrCl₄ (0.895 g, 3.84 mmol) in toluene (60 mL). After stirring for 3 minutes the solid ligand (5.00 g, 3.77 mmol) was added portionwise. The mixture was stirred for 8 h then the solvent was removed under reduced pressure overnight to afford a dark residue. Hexanes/toluene (10:1 70 mL) was added to the residue, the solution was shaken for a few minutes at room temperature, then this material was passed through a fritted funnel CELITE plug. The frit was extracted with hexanes (2×15 mL). The combined extracts were concentrated to dryness under reduced pressure. Pentane (20 mL) was added to the tan solid, the heterogeneous mixture was placed in the freezer (−35° C.) for 18 h. The brown pentane layer was removed using a pipette. The remaining material was dried under vacuum, which provided BPP-3 (4.50 g, yield: 83%) as a white powder:

¹H NMR (400 MHz, C₆D₆) δ 8.65-8.56 (m, 2H), 8.40 (dd, J=2.0, 0.7 Hz, 2H), 7.66-7.55 (m, 8H), 7.45 (d, J=1.9 Hz, 1H), 7.43 (d, J=1.9 Hz, 1H), 7.27 (d, J=2.5 Hz, 2H), 7.10 (d, J=3.2 Hz, 1H), 7.08 (d, J=3.1 Hz, 1H), 6.80 (ddd, J=9.0, 7.4, 3.2 Hz, 2H), 5.21 (dd, J=9.1, 4.7 Hz, 2H), 4.25 (d, J=13.9 Hz, 2H), 3.23 (d, J=14.0 Hz, 2H), 1.64-1.52 (m, 4H), 1.48 (s, 18H), 1.31 (s, 24H), 1.27 (s, 6H), 0.81 (s, 18H), 0.55 (t, J=7.3 Hz, 12H), 0.31 (hept, J=7.5 Hz, 2H), −0.84 (s, 6H); ¹⁹F NMR (376 MHz, C₆D₆) δ −116.71.

Synthesis of BPP-9:

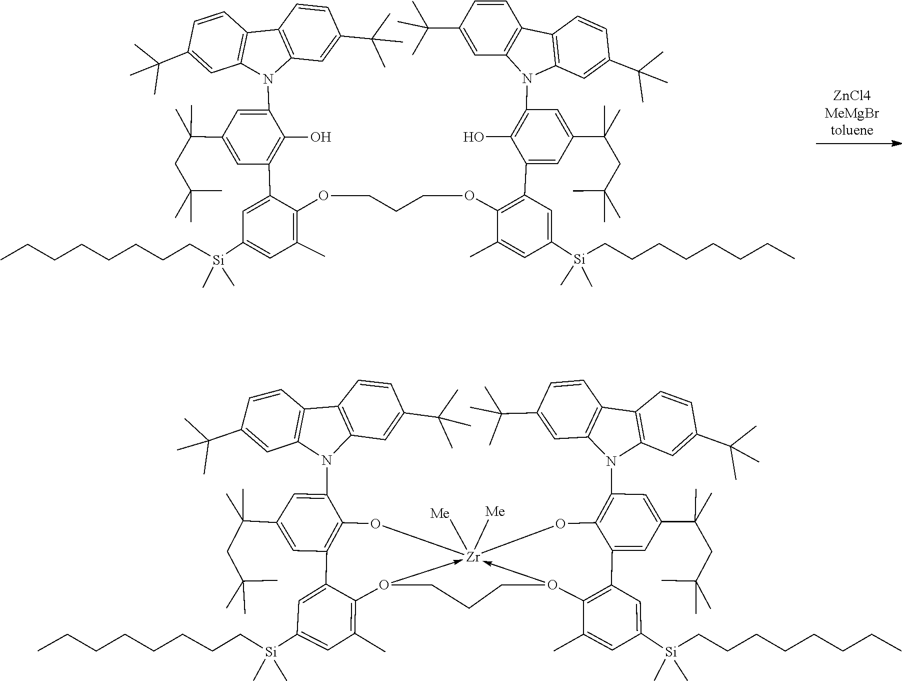

A 100 mL oven dried glass bottle was charged with ZrCl₄ (798 mg, 3.43 mmol), toluene (30 mL), and a stir bar. The solution was placed in the freezer and cooled to −30 C for 20 min. The solution was taken out of the freezer, and was treated with MeMgBr (4.35 mL, 13.1 mmol, 3 M in Et₂O) and stirred for 15 minutes. To the cold suspension, the BPP-9 ligand (5.00 g, 3.26 mmol) was added as a solid. The reaction was stirred at room temperature for 3 h, and then filtered through a fritted plastic funnel. The filtrate was dried under vacuum. The resulting solid was washed with hexanes, and dried under vacuum, providing BPP-9 as an off-white powder (3.31 g, 62%):

¹H NMR (400 MHz, Benzene-d₆) δ 8.19 (d, J=8.2 Hz, 2H), 8.03-7.96 (m, 4H), 7.87 (d, J=2.5 Hz, 2H), 7.81-7.76 (m, 2H), 7.64 (d, J=2.5 Hz, 2H), 7.56 (d, J=1.7 Hz, 2H), 7.51 (dd, J=8.2, 1.7 Hz, 2H), 7.30 (dd, J=8.3, 1.7 Hz, 2H), 7.06-7.01 (m, 2H), 3.57 (dt, J=9.9, 4.9 Hz, 2H), 3.42 (dt, J=10.3, 5.2 Hz, 2H), 1.79 (d, J=14.5 Hz, 2H), 1.66 (d, J=14.4 Hz, 2H), 1.60 (s, 18H), 1.46 (s, 6H), 1.42 (s, 6H), 1.37-1.22 (m, 50H), 0.94-0.91 (m, 24H), 0.62-0.56 (m, 4H), 0.11 (s, 6H), 0.08 (s, 6H), −0.64 (s, 6H).

Preparation of BPP-10

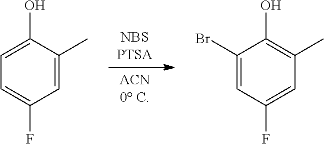

Synthesis of 2-bromo-4-fluoro-6-methyl-phenol: 1 L glass bottle was charged with acetonitrile (400 mL), 4-fluoro-6-methyl-phenol (50 g, 396.4 mmol), and p-toluenesulfonic acid (monohydrate) (75.6 g, 396 mmol), making sure everything was in solution. The solution was cooled to 0° C. with ice for 25 min (a precipitate formed). The cooled solution, was slowly treated with N-bromosuccinimide (70.55 g, 396.4 mmol) (over the course of approx. 5 min), and was allowed reach room temperature while stirring overnight. The reaction was analyzed by ¹⁹F NMR spectroscopy and GC/MS to confirm complete conversion. The volatiles were removed under vacuum, and the resulting solid was treated with dichloromethane (600 mL), cooled in the freezer (0° C.), and filtered through a large plug of silica gel. The silica gel was washed several times with cold CH₂Cl₂. The volatiles were removed under vacuum (1^{st} fraction yield: 46 g, 56%). ¹H NMR (400 MHz, Chloroform-d) δ 7.05 (ddd, J=7.7, 3.0, 0.7 Hz, 1H), 6.83 (ddt, J=8.7, 3.0, 0.8 Hz, 1H), 5.35 (s, 1H), 2.29 (d, J=0.7 Hz, 3H). ¹⁹F NMR (376 MHz, Chloroform-d) δ −122.84.

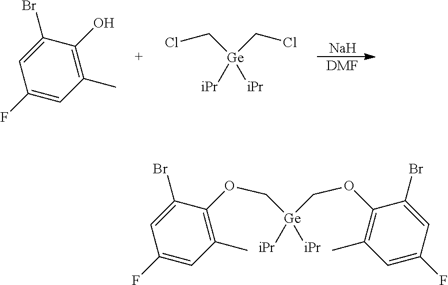

Synthesis of bis((2-bromo-4-fluoro-6-methylphenoxy)methyl)diisopropylgermane: In the glove box, in a 250 mL flask equipped with a magnetic stir bar, 95% NaH (1.76 g) (Caution H₂ is generated) was slowly added to a solution of 2-bromo-4-fluoro-6-methyl-phenol (15 g, 73.2 mmol) in N,N-dimethylformamide (DMF) (35 mL) until hydrogen evolution ceased. This mixture was stirred for 30 minutes at room temperature. After this time, the diisopropyl germyl dichloride (6.29 g, 24.4 mmol) was added. The mixture was warmed to 55° C. and held at this temperature for 18 h. The reaction was removed from the glove box and quenched with saturated aqueous NH₄Cl (20 mL) and H₂O (8 mL). Et₂O (30 mL) was added and the phases were transferred to a separatory funnel and separated. The aqueous phase was further extracted with Et₂O (20 mL), and the combined organic extracts were washed with brine (10 mL). The organic layer was then dried (MgSO₄), filtered, and concentrated to dryness. The crude residue was dry loaded onto silica gel and then purified using flash column chromatography (100 mL/min, pure hexanes with ethyl acetate ramping to 10% over 20 minutes) to afford a pale yellow oil as product. All clean fractions (some fractions contained <10% of starting phenol) were combined, and the final product was left under vacuum overnight (Yield: 9 g, 62%):

¹H NMR (400 MHz, Chloroform-d) δ 7.10 (dd, J=7.7, 3.0 Hz, 2H), 6.84 (ddd, J=8.8, 3.1, 0.8 Hz, 2H), 4.14 (s, 4H), 2.33 (s, 6H), 1.74 (hept, J=7.4 Hz, 2H), 1.35 (d, J=7.4 Hz, 12H); ¹⁹F NMR (376 MHz, Chloroform-d) δ −118.03.

Synthesis of BPP-10 Ligand

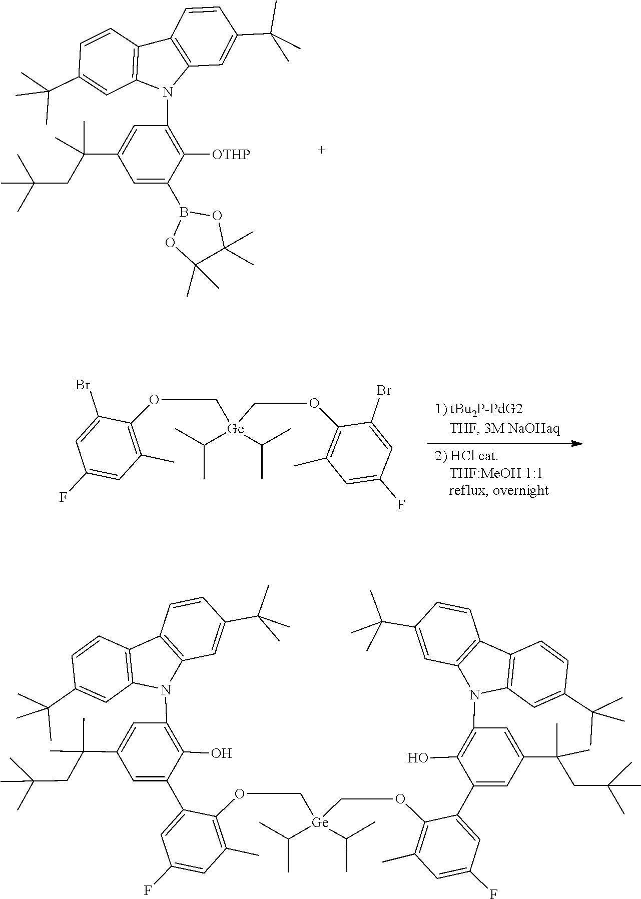

A 500 mL glass-bottle, equipped with a stir bar, was charged with 2,7-di-tert-butyl-9-(2-((tetrahydro-2H-pyran-2-yl)oxy)-3-(4,4,5,5-tetramethyl-1,3,2-dioxaborolan-2-yl)-5-(2,4,4-trimethylpentan-2-yl)phenyl)-9H-carbazole (Disclosed in WO2014105411 A1) (29.0 g, 41.9 mmol), bis((2-bromo-4-fluoro-6-methylphenoxy)methyl)diisopropylgermane (6.00 g, 8.65 mmol, contains 10% 2-bromo-4-fluoro-2-methyl-phenol), and THF (80 mL). The solution was heated to 55° C. and, while stirring, was treated with chloro[(tri-tert-butylphosphine)-2-(2-aminobiphenyl)]palladium(II) (tBu₃P-PdG2) (199 mg, 0.346 mmol, 4 mol %). An aqueous solution of NaOH (17.3 mL, 51.9 mmol, 3M) was purged with nitrogen for 20 min, and then added to the THF solution. The reaction was stirred overnight at 55° C. The aqueous phase was separated and discarded, and the remaining organic phase was diluted with diethyl ether and washed with brine twice. The solution was passed through a short plug of silica gel. The filtrate was dried on a rotary evaporator, dissolved in THF/methanol (40 mL/40 mL), treated with HCl (2 mL), and stirred overnight at 70° C. The solution was dried under vacuum, and purified by C18 reverse-phase column chromatography to provide the BPP-10 ligand as an off-white solid (Yield: 6.5 g, 54%):

¹H NMR (400 MHz, Chloroform-d) δ 8.01 (d, J=8.2 Hz, 4H), 7.42 (dd, J=25.5, 2.4 Hz, 4H), 7.32 (dd, J=8.2, 1.6 Hz, 4H), 7.17 (s, 4H), 6.87 (ddd, J=16.4, 8.8, 3.0 Hz, 4H), 6.18 (s, 2H), 3.79 (s, 4H), 2.12 (s, 6H), 1.71 (s, 6H), 1.56 (s, 4H), 1.38 (s, 12H), 1.31 (s, 36H), 0.83-0.73 (m, 30H); ¹⁹F NMR (376 MHz, Chloroform-d) δ −119.02.

Synthesis of BPP 10:

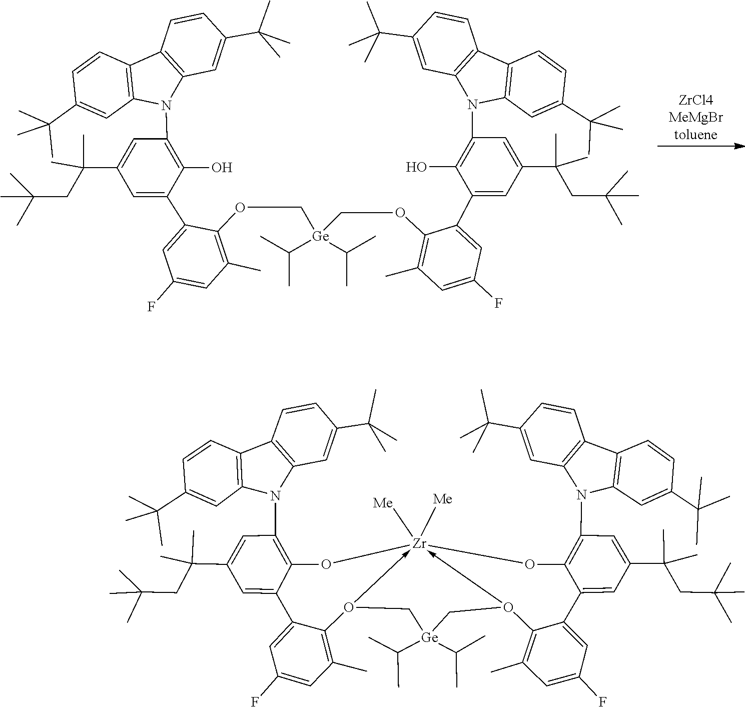

A 100 mL oven dried glass bottle was charged with ZrCl₄ (402 mg, 1.72 mmol), toluene (83 mL), and a stir bar. The solution was placed in the freezer and cooled to −30 C for 20 min. The solution was taken out of the freezer, and was treated with MeMgBr (2.4 mL, 7.1 mmol, 3 M in Et₂O) and stirred for 3 minutes. To the cold suspension, the BPP-10 ligand (2.3 g, 1.64 mmol) was added as a solid, and the residual powder was dissolved in cold toluene (3 mL) and added to the reaction. The reaction was stirred overnight at room temperature, and then filtered through a fritted plastic funnel. The filtrate was dried under vacuum, redissolved in toluene (40 mL), filtered again through a plug of CELITE, and dried again under vacuum. The resulting solid was washed with pentane (approx. 5 mL) and dried under vacuum, providing BPP-10 as an off-white powder (2.1 g, 84%):

¹H NMR (400 MHz, Benzene-d₆) δ 8.20 (dd, J=8.2, 0.5 Hz, 2H), 8.11 (dd, J=8.2, 0.6 Hz, 2H), 7.88-7.82 (m, 4H), 7.77 (d, J=2.6 Hz, 2H), 7.50 (dd, J=8.3, 1.7 Hz, 2H), 7.42-7.37 (m, 4H), 6.99 (dd, J=8.7, 3.1 Hz, 2H), 6.20-6.10 (m, 2H), 4.29 (d, J=12.2 Hz, 2H), 3.90 (d, J=12.2 Hz, 2H), 1.56 (s, 4H), 1.53 (s, 18H), 1.29 (s, 24H), 1.27 (s, 6H), 1.18 (s, 6H), 1.04-0.94 (m, 2H), 0.81 (d, J=7.4 Hz, 6H), 0.80 (s, 18H), 0.74 (d, J=7.4 Hz, 6H), −0.47 (s, 6H); ¹⁹F NMR (376 MHz, Benzene-d₆) δ −116.24.

Synthesis of BPP-12

### Preparation of bis((2-bromo-4-t-butylphenoxy)methyl)diisopropylsilane

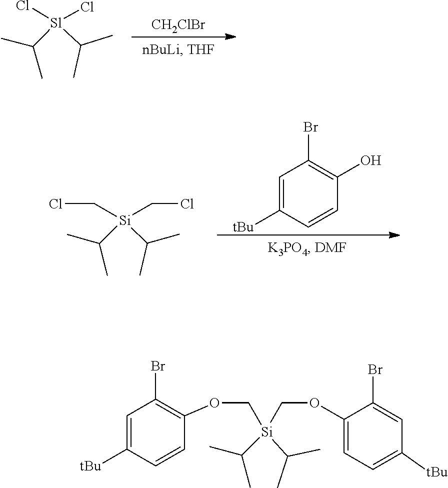

In a glovebox, diisopropyldichlorosilane (3.703 g, 20 mmol, 1.0 equiv) was dissolved in anhydrous THF (120 mL) in a 250 mL single-neck round-bottom flask. The flask was capped with a septum, sealed, taken out of glovebox, and cooled to −78° C. in a dry ice-acetone bath. Bromochloromethane (3.9 mL, 60 mmol, 3.0 equiv) was added. A solution of n-BuLi (18.4 mL, 46 mmol, 2.3 equiv) in hexane was added to the cooled wall of the flask over a period of 3h using a syringe pump. The mixture was allowed to warm up to room temperature overnight (16h) and saturated NH₄Cl (30 mL) was added. The two layers were separated. The aqueous layer was extracted with ether (2×50 mL). The combined organic layer was dried over MgSO₄, filtered and concentrated under reduced pressure. The crude product was used for the next step without further purification.

In a glove box, a 40 mL vial was charged with bis(chloromethyl)diisopropylsilane (2.14 g, 10 mmol, 1.0 equiv), 4-t-butyl-2-bromophenol (6.21 g, 27 mmol, 2.7 equiv), K₃PO₄ (7.46 g, 35 mmol, 3.5 equiv), and DMF (10 mL). The reaction mixture was stirred at 80° C. overnight. After cooling down to room temperature, the reaction mixture was purified by column chromatography using ether/hexane (0/100->30/70) as the eluent. Collected 4.4 g of a colorless oil, 73% overall yield after 2 steps.

¹H NMR (400 MHz, CDCl₃) δ 7.51 (d, J=2.4 Hz, 2H), 7.26 (dd, J=8.6, 2.4 Hz, 2H), 6.98 (d, J=8.6 Hz, 2H), 3.93 (s, 4H), 1.45-1.33 (m, 2H), 1.28 (s, 18H), 1.20 (d, J=7.3 Hz, 12H).

### Preparation of 6″,6″″-(((diisopropylsilanediyl)bis(methylene))bis(oxy))bis(3,3″,5-tri-tert-butyl-5′-methyl-[1,1′:3′,1″-terphenyl]-2′-ol)

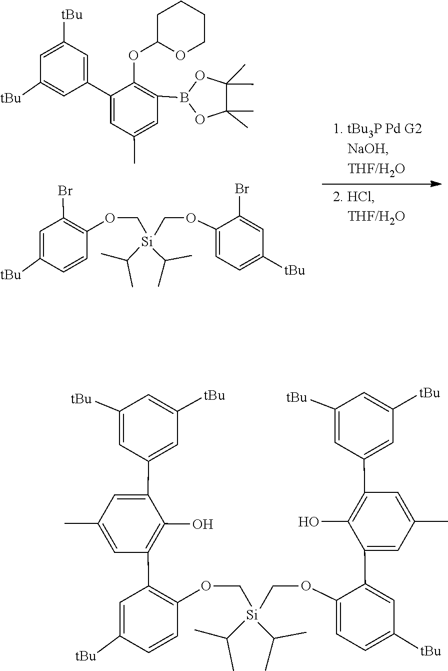

In a glove box, a 40 mL vial equipped with a stir bar was charged with bis((2-bromo-4-t-butylphenoxy)methyl)diisopropylsilane (1.20 g, 2.0 mmol, 1.0 equiv), 2-(3′,5′-di-tert-butyl-5-methyl-2-((tetrahydro-2H-pyran-2-yl)oxy)-[1,1′-biphenyl]-3-yl)-4,4,5,5-tetramethyl-1,3,2-dioxaborolane (2.54 g, 5.0 mmol, 2.5 equiv), tBu₃P Pd G2 (0.031 g, 0.06 mmol, 0.03 equiv), THF (3 mL), and NaOH 4 M solution (3.0 mL, 12.0 mmol, 6.0 equiv). The vial was heated under nitrogen at 55° C. for 2 hours. When completed, the top organic layer was extracted with ether and filtered through a short plug of silica gel. Solvents were removed under reduced pressure. The residue was dissolved in THF (10 mL) and MeOH (10 mL). Concentrated HCl (0.5 mL) was then added. The resulting mixture was heated at 75° C. for 2 hours then cooled to room temperature. Solvents were removed under reduced pressure. The residue was purified by reverse phase column chromatography using THF/MeCN (0/100->100/0) as the eluent. Collected 1.62 g of a white solid, 78% yield.

¹H NMR (400 MHz, CDCl₃) δ 7.39 (t, J=1.8 Hz, 2H), 7.36 (d, J=1.8 Hz, 4H), 7.29 (d, J=2.5 Hz, 2H), 7.22 (dd, J=8.6, 2.6 Hz, 2H), 7.10 (d, J=2.2 Hz, 2H), 6.94 (d, J=2.3, 2H), 6.75 (d, J=8.6 Hz, 2H), 5.37 (s, 2H), 3.61 (s, 4H), 2.32 (d, J=0.9 Hz, 6H), 1.33 (s, 36H), 1.29 (s, 18H), 0.90-0.81 (m, 2H), 0.73 (d, J=7.1 Hz, 12H).

Preparation of BPP-12

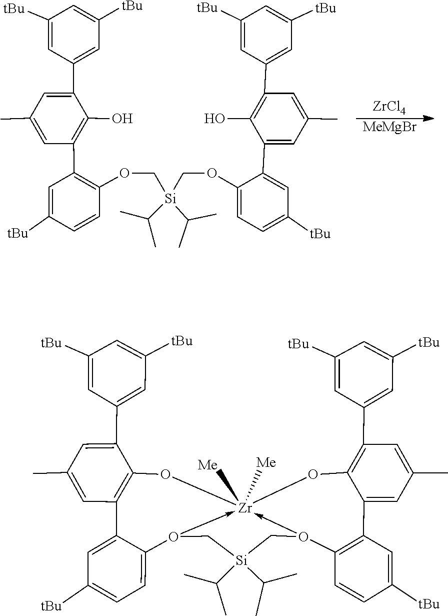

In a glovebox, an oven dried 40 mL vial with a stir bar was charged with ZrCl₄ (47 mg, 0.2 mmol, 1.0 equiv) and anhydrous toluene (6.0 mL). The vial was cooled to −30° C. in freezer for at least 30 minutes. The vial was taken out of freezer. MeMgBr (3 M, 0.29 mL, 0.86 mmol, 4.3 equiv) was added to the stirring suspension. After 2 minutes, 6″,6″″-(((diisopropylsilanediyl)bis(methylene))bis(oxy))bis(3,3″,5-tri-tert-butyl-5′-methyl-[1,1′:3′,1″-terphenyl]-2′-ol) (206 mg, 0.2 mmol, 1.0 equiv) was added as solid. The resulting mixture was stirred at room temperature overnight. Solvents were removed under vacuum to yield a dark solid which was washed with hexanes (10 mL) then extracted with toluene (12 mL). After filtering, the toluene extract was dried under vacuum. Collected 170 mg of a white solid, 74% yield.

¹H NMR (400 MHz, C₆D₆) δ 8.20-7.67 (m, 4H), 7.79 (t, J=1.8 Hz, 2H), 7.56 (d, J=2.5 Hz, 2H), 7.26 (d, J=2.4, 2H), 7.21 (d, J=2.4, 2H), 7.18 (d, J=2.4, 2H), 5.67 (d, J=8.6 Hz, 2H), 4.61 (d, J=13.5 Hz, 2H), 3.46 (d, J=13.5 Hz, 2H), 2.26 (s, 6H), 1.47 (s, 36H), 1.25 (s, 18H), 0.52 (dd, J=17.0, 7.5 Hz, 12H), 0.30-0.18 (m, 2H), −0.05 (s, 6H).

Synthesis of BPP-13

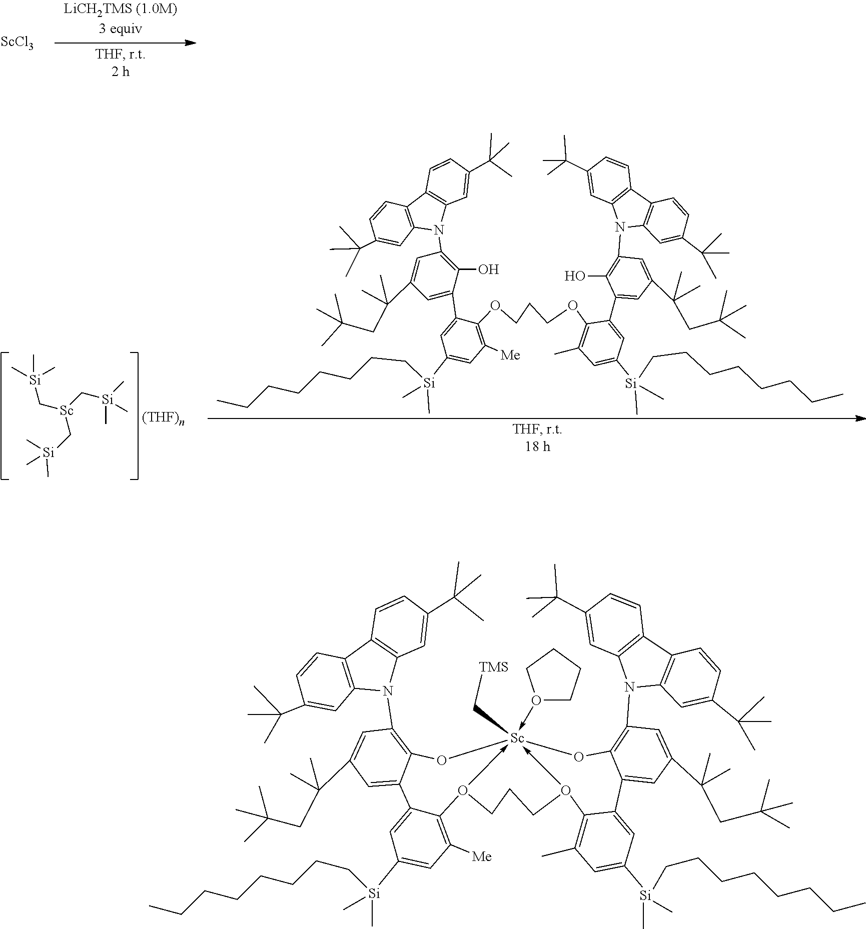

In a nitrogen glove box, an oven-dried vial was charged with ScCl₃ (0.016 g, 0.106 mmol), THF (ca. 50 mL), and a magnetic stir bar. The mixture was cooled at −30° C. and then LiCH₂TMS (1.0 M in pentane, 0.35 mL, 0.35 mmol) was added dropwise and then the mixture was stirred at room temperature for 1.5 h. To this mixture, 1 equiv of ligand formula i (0.168 g, 0.106 mmol) in THF (ca. 10 mL) was slowly added and the reaction mixture was allowed to be stirred at room temperature for 18 h. Solvent was then removed in vacuo to afford BPP-19 as a white solid (0.154 g, 83%).

### Example 2—Polymerization Reactions with Metal-Ligand Complexes and Comparative Activators and Hydrocarbyl-Modified Methylaluminoxanes Having Less than 25 Mole % of the Compound AlR^{A1}R^{B1}R^{C1} Based on Total Moles of Aluminum

Metal-ligand complexes 2, 4, and 11 were tested in a batch reactor using MMAO-A2 or MMAO-comp 2 as the activator, and the data are summarized in Tables 1-2. The dry weight efficiencies are higher when the catalyst was activated with MMAO-A2 as opposed to MMAO-comp 2.

TABLE 1
Hydrocarbyl-Modified Methylaluminoxane Compositions

| | | | | | Aluminum |
|---|---|---|---|---|---|
| | | | | | species as |
| | | Methane | Isobutane | Aluminum | AlR^{A1}R^{B1}R^{C1} |
| Name | Solvent | (mol %) | (mol %) | (mol %) | (%) |
| MMAO-A1 | Isopar E | 98.6 | 0.4 | 7 | 15 |
| MMAO- | Heptane | 65.6 | 33.3 | 6.8 | 38 |
| comp 1 | | | | | |
| MMAO-A2 | Isopar E | | | 6.76 | 11 |
| MMAO- | Heptane | | | 6.97 | 29 |
| comp 2 | | | | | |
| MMAO-B | Toluene | 99.6 | 0 | 7 | 20 |
| MMAO-C | Toluene | 99.7 | | 6.8 | 24 |

* MMAO-A1 and A2 are modified with n-octyl substituents such that the methyl:n-octyl ratio is approximately 6:1. MMAO-B is modified with n-octyl substituents such that the methyl:n-octyl ratio is approximately 19:1. All the substituents in MMAO-C are methyl.

TABLE 2
Batch reactor polymerization data of Bis-phenylphenoxy
Complexes using MMAO-comp 2 or MMAO-A2

| | H₂ | | Al(R₃) | Cat. | | Mw | Density | |
|---|---|---|---|---|---|---|---|---|
| BPP | (mmol) | Activator | (%)^{[B]} | (umol) | Eff.^{[A]} | (g/mol) | (g/cc) | PDI |
| 11 | 0 | MMAO- | 29 | 1.0 | 0.36 | 1,136,996 | 0.8709 | 3.07 |
| | | comp 2 | | | | | | |
| 11 | 0 | MMAO-A2 | 11 | 0.75 | 0.70 | 933,892 | 0.8676 | 2.23 |
| 4 | 0 | MMAO- | 29 | 0.5 | 0.65 | 90,785 | 0.8731 | 2.44 |
| | | comp 2 | | | | | | |
| 4 | 0 | MMAO-A2 | 11 | 0.2 | 1.78 | 81,478 | 0.8760 | 1.91 |

Polymerization conditions: 150° C., 1342 g ISOPAR E; 177 g 1-octene; 52 g ethylene; a total pressure of 230 psi; All MMAO at 100 ratio Al:Catalyst Metal.
^{[A]}The catalyst efficiency (Eff.) is measured as 10⁶ g polymer/g metal in the catalyst).
^{[B]}Aluminum species as AlR^{A1}R^{B1}R^{C1}.

TABLE 3
Batch reactor polymerization data of Bis-phenylphenoxy
Complexes using MMAO-comp 2 or MMAO-A2

| | H₂ | | Al(R₃) | Cat. | | Mw | Density | |
|---|---|---|---|---|---|---|---|---|
| BPP | (mmol) | Activator | (%)^{[B]} | (umol) | Eff.^{[A]} | (g/mol) | (g/cm³) | PDI |
| 2 | 0 | MMAO- | 29 | 1.0 | 0.55 | 317,498 | 0.8766 | 2.12 |
| | | comp 2 | | | | | | |
| 2 | 0 | MMAO-A2 | 11 | 0.325 | 1.14 | 284,349 | 0.8769 | 2.12 |
| 4 | 0 | MMAO- | 29 | 0.55 | 0.34 | 69,773 | 0.878 | 1.99 |
| | | comp 2 | | | | | | |
| 4 | 0 | MMAO-A2 | 11 | 0.168 | 1.47 | 70,575 | 0.8782 | 1.97 |

Polymerization conditions: 165° C., 1345 g ISOPAR E; 175 g 1-octene; 50 g ethylene; total pressure 237 psi; All MMAO at 100 ratio Al:Catalyst Metal.
^{[A]}The catalyst efficiency (Eff.) is measure as 10⁶ g polymer/g metal in the catalyst).
^{[B]}Aluminum species as AlR^{A1}R^{B1}R^{C1}.

TABLE 4
Continuous Process Ethylene/1-Octene Copolymerization Reactions.

| | | | Al | | | | | | | |
|---|---|---|---|---|---|---|---|---|---|---|
| | | | conc in | | % | | C2 | | | |
| | | Al(R)₃ | reactor | | Solids | H₂ | conversion | I₂ | | Density |
| BPP | MMAO | (%)^{[D]} | (ppm) | Eff.^{[C]} | (%)^{[A]} | (mol %) | (%) | (g/10 min) | I₁₀/I₂ | (g/cc) |
| 1 | MMAO-A1 | 15 | 2.0 | 27.0 | 14.5 | 0.06 | 80.7 | 1.7 | 12.0 | 0.8798 |
| 1 | MMAO-comp 1 | 38 | 5.0 | 8.46 | 14.1 | 0.09 | 80.5 | 1.9 | 10.3 | 0.8840 |
| 2 | MMAO-A1 | 15 | 2.0 | 7.76 | 14.1 | 0.21 | 80.9 | 1.8 | 7.8 | 0.8825 |
| 2 | MMAO-comp 1 | 38 | 2.0 | 1.35 | 13.7 | 0.24 | 80.5 | 2.0 | 7.3 | 0.8852 |
| 3 | MMAO-A1 | 15 | 2.0 | 40.4 | 15.0 | 0.05 | 80.8 | 1.9 | 9.9 | 0.8758 |
| 3 | MMAO-comp 1 | 38 | 6.0 | 2.38 | 14.4 | 0.1 | 80.5 | 2.1 | 9.5 | 0.8773 |
| 4 | MMAO-A1 | 15 | 2.0 | 55.4 | 14.8 | 0.0 | 80.1 | 11.5 | 9.5 | 0.8779 |
| 4 | MMAO-comp 1 | 38 | | N/A | | | | | | |
| 5 | MMAO-A1 | 15 | 0.97 | 38.2 | 15.2 | 0.0 | 80.9 | 140 | N/D | 0.8700 |
| 5¹ | MMAO-comp 1 | 38 | 9.8 | 1.22 | 8.14 | 0.0 | 57.6 | 146 | N/D | 0.8756 |
| 5 | MMAO-B | 20 | 2.0 | 42.0 | 15.1 | 0.0 | 80.8 | 129 | N/D | 0.8716 |
| 5 | MMAO-C | 24 | 2.0 | 41.6 | 14.9 | 0.0 | 80.7 | 131 | N/D | 0.8712 |
| 6 | MMAO-A1 | 15 | 2.0 | 12.3 | 13.7 | 0.37 | 81.0 | 2.2 | 5.9 | 0.8869 |
| 6 | MMAO-comp 1 | 38 | 2.0 | 2.74 | 13.6 | 0.37 | 81.2 | 2.1 | 5.9 | 0.8890 |
| 6 | MMAO-B | 20 | 2.0 | 10.8 | 13.5 | 0.35 | 80.8 | 2.1 | 6.1 | 0.8867 |
| 6 | MMAO-C | 24 | 2.0 | 9.89 | 13.6 | 0.36 | 80.6 | 2.0 | 6.0 | 0.8848 |
| 7² | MMAO-A1 | 15 | 5.8 | 0.72 | 14.2 | 0.46 | 80.9 | 1.6 | 7.2 | 0.8788 |
| 7 | MMAO-comp 1 | 38 | | N/A | | | | | | |
| 12 | MMAO-A1 | 15 | 2.0 | 13.6 | 13.8 | 0.38 | 80.5 | 2.1 | 6.1 | 0.8865 |
| 12 | MMAO-comp 1 | 38 | 2.0 | 4.78 | 13.8 | 0.36 | 80.7 | 1.9 | 5.9 | 0.8864 |

Polymerization at reactor temperature of 160° C., feed flows of 3.4 kg/h of ethylene, 3.3 kg/h of 1-octene, 21 kg/h ISOPAR E,
^{[A]}% Solids is the concentration of polymer in the reactor.
^{[B]}H₂ (mol %) is defined as the mole fraction of hydrogen, relative to ethylene, fed into the reactor.
^{[C]}The efficiency (Eff.) is measured as 10⁶ g polymer/g metal in the catalyst component). Ethylene conversion is measured as the difference between the ethylene fed to the reacor relative to the amount exiting the reactor, expressed as a percentage.
¹Reactor temperature = 153° C., 2.5 kg/h of ethylene, 3.3 kg/h of 1-octene, 21 kg/h ISOPAR E.
²Reactor temperature of 160° C., 3.4 kg/h of ethylene, 2.4 kg/h of 1-octene, 22 kg/h ISOPAR E.
N/D = Not determined.
^{[D]}Aluminum species as AlR^{A1}R^{B1}R^{C1}.
N/A = Unable to achieve steady state reaction under these reactor conditions.

TABLE 5
Continuous Process Ethylene/1-Octene Copolymerization Reactions.

| | | | Al | | | | | | | |
|---|---|---|---|---|---|---|---|---|---|---|
| | | | conc in | | % | | C2 | | | |
| | | Al(R)₃ | reactor | | Solids | H₂ | conversion | I₂ | | Density |
| BPP | MMAO | (%)^{[D]} | (ppm) | Eff.^{[C]} | (%)^{[A]} | (mol %) | (%) | (g/10 min) | I₁₀/I₂ | (g/cc) |
| 9 | MMAO-A1 | 15 | 2.0 | 125 | 16.0 | 0.0 | 85.3 | 8.9 | 6.24 | 0.9375 |
| 9 | MMAO- | 38 | 2.0 | 31.5 | 16.2 | 0.0 | 85.9 | 8.3 | 6.21 | 0.9376 |
| | comp 1 | | | | | | | | | |
| 10 | MMAO-A1 | 15 | 2.0 | 22.6 | 12.5 | 0.26 | 88.3 | 2.0 | 5.38 | 0.9390 |
| 10 | MMAO- | 38 | 5.4 | 1.47 | 15.9 | 0.35 | 84.8 | 3.2 | 5.91 | 0.9410 |
| | comp 1 | | | | | | | | | |

Polymerization at reactor temperature of 190° C., 4.6 kg/h of ethylene, 2.0 kg/h of 1-octene, 21 kg/h ISOPAR E,
^{[A]}% Solids is the concentration of polymer in the reactor.
^{[B]}H₂ (mol %) is defined as the mole fraction of hydrogen, relative to ethylene, fed into the reactor.
Ethylene conversion is measured as the difference between the ethylene fed to the reactor relative to the amount exiting the reactor, espressed as a percentage.
^{[C]}The efficiency (Eff.) is measured as 10⁶ g polymer/g metal in the catalyst).
^{[D]}Aluminum species as AlR^{A1}R^{B1}R^{C1}

TABLE 6
Batch reactor polymerization data of BPP-13

| | Aluminum | | | | | | |
|---|---|---|---|---|---|---|---|
| | AlR^{A1}R^{B1}R^{C1} | Al:Sc | | Tₘ | Mn | | Mw |
| MMAO | (%) | ratio | Eff.^{[A]} | (° C.) | (g/mol) | PDI | (g/mol) |
| MMAO-A1 | 15 | 20 | 0.73 | 132.59 | 100,988 | 1.99 | 173,471 |
| MMAO-A1 | 15 | 50 | 0.68 | 132.77 | 104,529 | 1.96 | 177,162 |
| MMAO-A1 | 15 | 100 | 0.56 | 132.72 | 100,966 | 2.00 | 166,684 |
| MMAO- | 38 | 20 | 0.84 | 132.49 | 97,256 | 1.96 | 162,902 |
| Comp 1 | | | | | | | |
| MMAO- | 38 | 50 | 0.69 | 131.79 | 113,401 | 1.95 | 189,574 |
| Comp 1 | | | | | | | |
| MMAO- | 38 | 100 | 0.41 | 131.97 | 114,469 | 1.97 | 189,631 |
| Comp 1 | | | | | | | |

Polymerization conditions: 190° C., 1250 g ISOPAR E; 65 g octene; 85 g ethylene; total pressure 415 psi; reaction time = 10 min.
^{[A]}Efficiency (Eff) is calculated based of the amount of ethylene uptake and is expressed as 10⁶ g ethylene uptake/g metal in the catalyst).

### Equipment Standards

All solvents and reagents are obtained from commercial sources and used as received unless otherwise noted. Anhydrous toluene, hexanes, tetrahydrofuran, and diethyl ether are purified via passage through activated alumina and, in some cases, Q-5 reactant. Solvents used for experiments performed in a nitrogen-filled glovebox are further dried by storage over activated 4 Å molecular sieves. Glassware for moisture-sensitive reactions is dried in an oven overnight prior to use. NMR spectra are recorded on Varian 400-MR and VNMRS-500 spectrometers. LC-MS analyses are performed using a Waters e2695 Separations Module coupled with a Waters 2424 ELS detector, a Waters 2998 PDA detector, and a Waters 3100 ESI mass detector. LC-MS separations are performed on an XBridge C18 3.5 μm 2.1×50 mm column using a 5:95 to 100:0 acetonitrile to water gradient with 0.10% formic acid as the ionizing agent. HRMS analyses are performed using an Agilent 1290 Infinity LC with a Zorbax Eclipse Plus C18 1.8 μm 2.1×50 mm column coupled with an Agilent 6230 TOF Mass Spectrometer with electrospray ionization. ¹H NMR data are reported as follows: chemical shift (multiplicity (br=broad, s=singlet, d=doublet, t=triplet, q=quartet, p=pentet, sex=sextet, sept=septet and m=multiplet), integration, and assignment). Chemical shifts for ¹H NMR data are reported in ppm downfield from internal tetramethylsilane (TMS, δ scale) using residual protons in the deuterated solvent as references. ¹³C NMR data are determined with ¹H decoupling, and the chemical shifts are reported downfield from tetramethylsilane (TMS, δ scale) in ppm versus the using residual carbons in the deuterated solvent as references.

1. A process of polymerizing olefin monomers, the process comprising reacting ethylene and optionally one or more olefin monomers in the presence of a catalyst system, wherein the catalyst system comprises:
hydrocarbyl-modified methylaluminoxane having less than 25 mole percent trihydrocarbyl aluminum compounds AlR^{A1}R^{B1}R^{C1} based on the total moles of aluminum in the hydrocarbyl-modified methylaluminoxane, where R^{A1}, R^{B1}, and R^{C1} are independently linear (C₁-C₄₀)alkyl, branched (C₁-C₄₀)alkyl, or (C₆-C₄₀)aryl; and
one or more metal-ligand complexes according to formula (I): 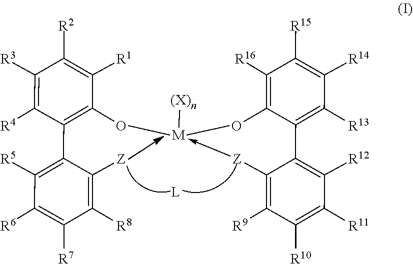
where:
M is titanium, zirconium, hafnium, scandium, yttrium, or an element of the lanthanide series of the periodic table;
n is 1, 2, or 3;
each X is a monodentate ligand independently chosen from unsaturated (C₂-C₅₀)hydrocarbon, unsaturated (C₂-C₅₀)heterohydrocarbon, saturated (C₂-C₅₀)heterohydrocarbon, (C₁-C₅₀)hydrocarbyl, (C₆-C₅₀)aryl, (C₆-C₅₀)heteroaryl, cyclopentadienyl, substituted cyclopentadienyl, (C₄-C₁₂)diene, halogen, —N(R^{N})₂, and —N(R^{N})COR^{C};
the metal-ligand complex is overall charge-neutral;
each Z is independently chosen from —O—, —S—, —N(R^{N})—, or —P(R^{P})—;
R¹ and R¹⁶ are independently selected from the group consisting of —H, (C₁-C₄₀)hydrocarbyl, (C₁-C₄₀)heterohydrocarbyl, —Si(R^{C})₃, —Ge(R^{C})₃, P(R^{P})₂, —N(R^{N})₂, —OR^{C}, —SR^{C}, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, halogen, radicals having formula (II), radicals having formula (III), and radicals having formula (IV): 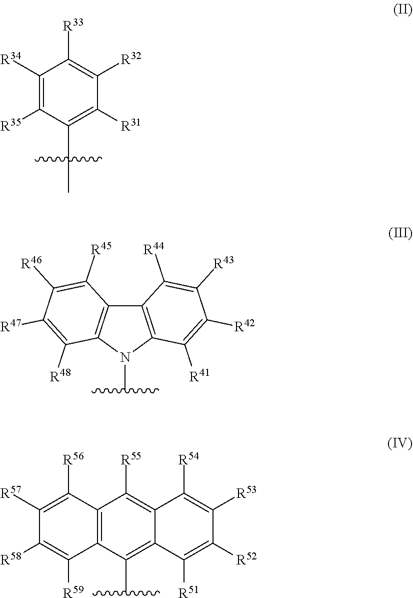
where each of R³¹⁻³⁵, R⁴¹⁻⁴⁸, and R⁵¹⁻⁵⁹ is independently chosen from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, or halogen;
R², R³, R⁴, R⁵, R⁶, R⁷, R⁸, R⁹, R¹⁰, R¹¹, R¹², R¹³, R¹⁴, and R¹⁵ are independently selected from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂—OR^{C}, SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R)—, (R^{C})₂NC(O)—, and halogen;
L is (C₁-C₄₀)hydrocarbylene or (C₂-C₄₀)heterohydrocarbylene; and
each R^{C}, R^{P}, and R^{N} in formula (I) is independently a (C₁-C₃₀)hydrocarbyl, (C₁-C₃₀)heterohydrocarbyl, or —H.

2. The polymerization process according to claim 1, where the hydrocarbyl-modified methylaluminoxane has less than 20 mole percent of trihydrocarbyl aluminum based on the total moles of aluminum in the hydrocarbyl-modified methylaluminoxane.

3. The polymerization process according to claim 1, where the hydrocarbyl-modified methylaluminoxane has less than 15 mole percent of trihydrocarbyl aluminum based on the total moles of aluminum in the hydrocarbyl-modified methylaluminoxane; or where the hydrocarbyl-modified methylaluminoxane has less than 10 mole percent of trihydrocarbyl aluminum based on the total moles of aluminum in the hydrocarbyl-modified methylaluminoxane.

4. (canceled)

5. The polymerization process according to claim 1, where the hydrocarbyl-modified methylaluminoxane is modified methylaluminoxane.

6. (canceled)

7. The polymerization process according to claim 1, wherein at least one of R¹ and R¹⁶ is a radical having formula (III).

8. The polymerization process according to claim 7, wherein R⁴² and R⁴⁷ are (C₁-C₂₀)hydrocarbyl or —Si[(C₁-C₂₀)hydrocarbyl]₃; or wherein R⁴³ and R⁴⁶ are (C₁-C₂₀)hydrocarbyl or —Si[(C₁-C₂₀)hydrocarbyl]₃.

9. (canceled)

10. The polymerization process according to claim 1, wherein at least one of R¹ and R¹⁶ is a radical having formula (II).

11. The polymerization process according to claim 10, wherein R³² and R³⁴ are (C₁-C₁₂)hydrocarbyl or —Si[(C₁-C₂₀)hydrocarbyl]₃.

12. The polymerization process according to claim 1, wherein at least one of R¹ and R¹⁶ is a radical having formula (IV).

13. The polymerization process according to claim 12, wherein at least two of R⁵², R⁵³, R⁵⁵, R⁵⁷, and R⁵⁸ are (C₁-C₂₀)hydrocarbyl or —Si[(C₁-C₂₀)hydrocarbyl]₃.

14. (canceled)

15. The polymerization process according to claim 1, wherein R⁸ and R⁹ are independently (C₁-C₄)alkyl.

16. The polymerization process according to claim 1, wherein R³ and R¹⁴ are (C₁-C₂₀)alkyl.

17. (canceled)

18. The polymerization process according to claim 1, wherein R⁶ and R¹¹ are tert-butyl.

19. The polymerization process according to claim 1, wherein R³ and R¹⁴ are tert-octyl or n-octyl.

20. The polymerization process according to claim 1, wherein M is Zr or Sc.

21. The polymerization process according to claim 1, wherein L is chosen from —CH₂(CH₂)ₘCH₂—, where m is 1 to 3, —CH₂Si(R^{C})(R^{D})CH₂—, —CH₂Ge(R^{C})(R^{D})CH₂—, —CH(CH₃)CH₂CH(CH₃)—, bis(methylene)cyclohexan-1,2-diyl; —CH₂CH(R^{C})CH₂—, —CH₂C(R^{C})₂CH₂—, where each R^{C} in L is (C₁-C₂₀)hydrocarbyl and R^{D} in L is (C₁-C₂₀)hydrocarbyl.

22. The polymerization process according to claim 1, wherein the catalyst system does not contain a borate activator.

23. The polymerization process according to claim 1, wherein the olefin monomer is (C₃-C₂₀)α-olefin.

24. The polymerization process according to claim 1, wherein the olefin monomer is not (C₃-C₂₀)α-olefin.

25. The polymerization process according to claim 1, wherein the olefin monomer is cyclic olefin.

26. (canceled)
